(19) United States
(12) Patent Application Publication
(10) Pub. No.: US 2026/0118253 A1
(43) Pub. Date: Apr. 30, 2026

(54) CYTOMETRIC CONTROL, REFERENCE, AND CALIBRATION USING HYDROGEL PARTICLES

(71) Applicant: Slingshot Biosciences, Inc., Emeryville, CA (US)

(72) Inventors: Jeffrey KIM, Berkeley, CA (US); Anh-Tuan NGUYEN, San Francisco, CA (US); Juan ARMAS, Emeryville, CA (US); Daixuan ZHANG, Emeryville, CA (US); Martina DE GEUS, Berkeley, CA (US); Solomon STONEBLOOM, Emeryville, CA (US)

(21) Appl. No.: 19/354,052

(22) Filed: Oct. 9, 2025

Related U.S. Application Data
(63) Continuation of application No. PCT/US2024/024683, filed on Apr. 15, 2024.
(60) Provisional application No. 63/496,017, filed on Apr. 13, 2023.
(60) Provisional application No. 63/539,496, filed on Sep. 20, 2023.

(51) Int. Cl. G01N 15/14; G01N 15/10; G01N 15/1434

(52) U.S. Cl. CPC G01N 15/1459; G01N 15/1434; G01N 2015/1006

(57) ABSTRACT

A non-transitory, processor-readable medium stores instructions that, when executed by a processor, cause the processor to receive, at a first time, a first data array associated with a first cytometric instrument. The first data array includes a set of scatter signal datapoints that includes data representing: at least one low forward scatter signal output, at least one high forward scatter signal output, at least one low side scatter signal output, and at least one high side scatter signal output. At a second time subsequent to the first time, a cytometric instrument parameter is adjusted based on the first data array, and/or a first cytometric measurement of the first cytometric instrument is reconciled with a second cytometric measurement of a second cytometric instrument different from the first cytometric instrument, based on at least one of the first data array or a second data array associated with the second cytometric instrument.

### CROSS-REFERENCE TO RELATED APPLICATIONS

This application is a continuation of International Patent Application No. PCT/US2024/024683, filed on Apr. 15, 2024, which claims the benefit of U.S. Provisional Patent Application No. 63/496,017, filed on Apr. 13, 2023, and U.S. Provisional Patent Application No. 63/539,496, filed on Sep. 20, 2023, each of which is hereby incorporated by reference in its entirety. This application is related to U.S. Pat. No. 10,753,846, issued Aug. 25, 2020, titled “Hydrogel Particles with Tunable Optical Properties and Methods for Using the Same,” the entire contents of which are incorporated by reference herein in their entirety for all purposes.

### FIELD

The present disclosure relates to cell analysis techniques such as flow cytometry, and more specifically, to the adjustment and cross-calibration of cell analysis instrumentation based on multi-population datasets associated with hydrogel particles.

### BACKGROUND

Flow cytometry and high-throughput cytometric analysis (e.g., high-content imaging) are techniques that allow for the rapid separation, counting, and characterization of individual cells, and are routinely used in clinical and laboratory settings for a variety of applications. Cytometric devices are known in the art and include commercially available devices for performing flow cytometry and FACS, hematology, and high-content imaging.

Cytometers vary in hardware components and measurement principles, resulting in different scaling and sensitivity for scatter data acquisition. However, while there are multi-level reference materials for fluorescence that are widely adopted and commercially available, no such standard exists for simultaneous forward (FSC) and side-scatter (SSC), making it particularly challenging to standardize scatter measurements across instruments. To date, the mainstream method is to simply measure patient samples in a trial-and-error fashion and manually adjust settings until results agree. This is not only time consuming, but it poses a biohazard, increases sample variability, and is impractical for rare or costly samples. Accordingly, a new approach is needed.

### SUMMARY

In some embodiments, a non-transitory, processor-readable medium stores instructions that, when executed by a processor, cause the processor to receive, at a first time, a first data array associated with a first cytometric instrument. The first data array includes a set of scatter signal datapoints that includes data representing at least one low forward scatter signal output, at least one high forward scatter signal output, at least one low side scatter signal output, and at least one high side scatter signal output. At a second time subsequent to the first time, a cytometric instrument parameter is adjusted based on the first data array, and/or a first cytometric measurement of the first cytometric instrument is reconciled with a second cytometric measurement of a second cytometric instrument different from the first cytometric instrument, based on at least one of the first data array or a second data array associated with the second cytometric instrument.

In some embodiments, a non-transitory, processor-readable medium stores instructions that, when executed by a processor, cause the processor to identify a first plurality of scatter signal datapoints generated by a first flow cytometer. The first plurality of scatter signal datapoints includes (i) data representing forward scatter at a first signal output level, (ii) data representing forward scatter at a second signal output level greater than the first signal output level, (iii) data representing forward scatter at a third signal output level greater than the second signal output level, (iv) data representing side scatter at a fourth signal output level, (v) data representing side scatter at a fifth signal output level greater than the fourth signal output level, and (vi) data representing side scatter at a sixth signal output level greater than the fifth signal output level. The non-transitory, processor-readable medium also stores instructions that, when executed by the processor, cause the processor to at least one of: automatically adjust a control parameter of the first flow cytometer based on the first plurality of scatter signal datapoints, or reconcile a first set of at least one measurement of the first flow cytometer with a second set of at least one measurement of a second flow cytometer different from the first flow cytometer, based on at least one of the first plurality of scatter signal datapoints or a second plurality of scatter signal datapoints associated with the second flow cytometer.

### BRIEF DESCRIPTION OF THE DRAWINGS

The patent or application file contains at least one drawing executed in color. Copies of this patent or patent application publication with color drawings will be provided by Office upon request and payment of the necessary fee.

It is to be understood that the drawings primarily are for illustrative purposes and are not intended to limit the scope of the subject matter described herein.

FIGS. 1A-1B are flow cytometer images, plotting forward scatter (FSC) versus side scatter (SSC), showing nine unique signal populations, according to some embodiments. FIG. 1C shows a flow cytometer image plotting forward scatter-area (FSC-A) versus forward scatter-height (FSC-H). The nine unique signal populations shown in the FSC-A versus SSC-A plot of FIGS. 1A-1B, which appear as three unique signal populations shown in the FSC-A versus FSC-H plot of FIG. 1C, may be generated by a set of hydrogel particles referred to herein as “ScatterGrid” or as “ScatterBridge.” The unique signal populations may be based on the particular composition and size of the hydrogel particles that generate the associated scatter. For instance, while each of ScatterGrid and ScatterBridge generates nine unique signal populations that can be used in the same methods discussed herein, ScatterGrid provides a generally applicable signal array based on a fixed set of compositions and sizes of hydrogel particles while ScatterBridge provides an adaptable signal array, wherein the compositions and sizes of hydrogel particles resulting in the signal array may be based on instrument gain settings and parameters and/or a cell population of interest in order to facilitate cytometry thereof. ScatterBridge permits the “linear” range of the scatter profile to be tailored to a particular use case. FIG. 1A shoes ScatterGrid-based scatter data in nine unique signal populations. FIG. 1B and FIG. 1C show ScatterBridge-based scatter data.

FIG. 2 is a diagram showing a system for adjusting and/or cross-calibrating of flow cytometers using ScatterGrid-based scatter data (e.g., multi-population datasets generated using hydrogel particles), according to some embodiments.

FIGS. 3A, 4A, and 5A depict exemplary arrays of ScatterGrid-based scatter data, each one sequentially annotating subsets of data generated using hydrogel particles (e.g., beads) of varying average diameters (10 micrometers (μm), 20 μm, and 25 μm, respectively), according to some embodiments. In other words, the three gated signal populations in FIG. 3A are low forward scatter datasets generated by 10 μm average diameter hydrogel particles. The three gated signal populations in FIG. 4A are medium (or high when only two scatter levels are utilized) forward scatter datasets generated by 20 μm average diameter hydrogel particles. The three gated signal populations in FIG. 5A are high forward scatter datasets generated by 25 μm average diameter hydrogel particles.

FIGS. 3B-3C, 4B-4C, and 5B-5C depict exemplary arrays of ScatterBridge-based scatter data, each one sequentially annotating subsets of data generated using hydrogel particles (e.g., beads) of varying average diameters (10 micrometers (μm), 14 μm, and 18 μm, respectively), according to some embodiments. In other words, the three gated signal populations in FIGS. 3B-3C are low forward scatter datasets generated by 10 μm average diameter hydrogel particles. The three gated signal populations in FIGS. 4B-3C are medium (or high when only two scatter levels are utilized) forward scatter datasets generated by 14 μm average diameter hydrogel particles. The three gated signal populations in FIGS. 5B-5C are high forward scatter datasets generated by 18 μm average diameter hydrogel particles.

FIGS. 6A-6C show exemplary ScatterGrid-based scatter data sets generated by three different flow cytometers (a Cytek® NL-2000 flow cytometer, a Cytek® Aurora flow cytometer, and a Beckman Coulter® Cytoflex 5 flow cytometer, respectively), each ScatterGrid-based scatter data set including nine gated populations (or gated hydrogel populations), in accordance with some embodiments. As used herein, a “gated population” can refer to a set of sub-selected data points (see, e.g., the rectangular boxes in FIGS. 6A-6C, which are “gates” denoting populations of events).

FIGS. 7A-7B show exemplary ScatterGrid-based scatter data sets generated by two different flow cytometers (a BD® Biosciences FACSLyric™ flow cytometer and a Beckman Coulter™ Cytoflex LX flow cytometer, respectively), each ScatterGrid-based scatter data set including nine populations (sets of sub-selected data points), in accordance with some embodiments.

FIGS. 8A-8C show ScatterGrid-based scatter data sets generated by a single Cytek® NL-2000 flow cytometer at three different times (before preventive maintenance of the Cytek® NL-2000 flow cytometer, after preventive maintenance of the Cytek® NL-2000 flow cytometer, and after preventive maintenance with an adjustment to the FSC gain of the Cytek® NL-2000 flow cytometer, respectively), in accordance with an embodiment.

FIG. 9A is a plot showing first data generated by a first flow cytometer, the first data including ScatterGrid-based scatter data, data generated using TruCyte TBNK biomarker mimics (synthetic cells), and data generated using biological cells, in accordance with an embodiment.

FIG. 9B is a plot showing second data generated by a second flow cytometer (a Cytek® Aurora flow cytometer), the second data including ScatterGrid-based scatter data, the plot also showing two populations of hydrogel particles meant to mimic the forward scatter and side scatter signals of the biological samples analyzed on the first flow cytometer, in accordance with an embodiment.

FIG. 10 is a flow diagram showing a method for adjusting a cytometric instrument and/or reconciling cytometric measurements, based on ScatterGrid-based or ScatterBridge-based scatter data, according to some embodiments.

FIG. 11 is a flow diagram showing a method for automatically adjusting a control parameter of a flow cytometer and/or reconciling flow cytometer measurements, based on ScatterGrid-based or ScatterBridge-based scatter data, according to some embodiments.

FIGS. 12A-12C are graphical interpretations of implementations of automatic adjustments of a control parameter of a flow cytometer and/or reconciliation of flow cytometer measurements, according to some embodiments.

FIG. 13 is a graphical representation of a flow cytometry scatter profile of ScatterBridge-based scatter data producing a 3×3 FSC/SSC signal on a Cytek® Aurora Flow cytometer.

FIG. 14A is a histogram of forward scatter of select populations of ScatterBridge-based scatter data, as measured on a Cytek® Aurora Flow cytometer, and FIG. 14B is a histogram of side scatter of select populations of ScatterBridge-based scatter data, as measured on a Cytek® Aurora Flow cytometer. As shown in FIG. 14A and FIG. 14B, the select populations of ScatterBridge-based scatter data produce a multi-level signal.

FIGS. 15A and 15B are graphical representations of flow cytometry scatter profiles of ScatterBridge-based scatter data, producing a 3×3 FSC/SSC signal on a Beckman Coulter® CytoFLEX S (FIG. 15A) and a BD® FACSLyric™ flow cytometer (FIG. 15B). FIG. 15A and FIG. 15B demonstrate inter-instrument variability that can be corrected for and/or controlled for by use of the ScatterBridge-based scatter data.

FIG. 16 is a graphical representation of a flow cytometry scatter profile of ScatterBridge-based scatter data (S) overlayed with CAR-T cells (1) and THP-1 cells (2) on a Cytek® Aurora Flow cytometer.

FIG. 17 is a flow diagram of a method for automatic gating for identification of a population of cells, in accordance with some embodiments.

FIGS. 18A-18D are graphical representations of automated gating, in accordance with some embodiments.

FIG. 19 is a graphical depiction demonstrating the relative position of biological cells form Table 1 with respect to ScatterBridge.

### DETAILED DESCRIPTION

Flow cytometry and high-throughput cytometric analysis can be used to assay beads (e.g., for biochemical measurements). In some such implementations, a beam of light is directed onto a focused stream of liquid containing the beads. Multiple detectors are then aimed at the point where the stream passes through the light beam, with one detector in line with the light beam (e.g., to detect forward scatter (“FSC”)) and several detectors perpendicular to the light beam (e.g., to detect side scatter (“SSC”)). FSC and SSC measurements are typically referred to as “passive optical properties.” For particles such as cells (e.g., human cells), FSC typically correlates with cell volume, while SSC typically correlates with the inner complexity, or granularity, of the particle (e.g., shape of the nucleus, the amount and type of cytoplasmic granules, or the membrane roughness). As a result of these correlations, different specific cell types can exhibit different FSC and SSC, such that cell types can be distinguished from one another based on their passive optical properties in flow cytometry. These measurements—FSC and SSC—form the basis of cytometric analysis in clinical and research settings. Most synthetic or polymer products used in such cellular analyses are made of (or substantially comprise) polystyrene or latex—opaque polymers that generally have fixed FSC and SSC values based on the diameter of the particle itself. As such, polystyrene particles of the same diameter generally cannot be distinguished from one another based on passive optical properties (FSC and SSC) alone.

Nevertheless, many flow cytometer vendors use a quality control (QC) material, such as beads, to track signal drift of their instruments over time. Typically, for forward scatter (FSC)/side scatter (SSC) calibration, one single population of beads with a known (or “characteristic”) FSC/SSC position on a light scatter plot is used as a reference material. This, however, is equivalent to calibrating a linear instrument using a single point calibration. While providing some basic idea about drift, this type of calibration typically cannot reveal degradation or inconsistencies in the linearity and scaling of scatter measurements.

Additionally, different cytometers use different measurement principles, which typically results in different scaling and sensitivity. While some known multi-level reference materials (such as Spherotech Rainbow beads) exist for fluorescence, no such standard exists for forward and side scatter. In other words, known calibration beads for use in flow cytometry provide controls for fluorescence intensity measurements and cell counts, but not for forward scatter and side scatter signal intensities. As such, it is particularly challenging to cross-compare results from different cytometers, which hinders scientific collaboration and increases development time. Moreover, to cross-compare results from different cytometers, known methods involve simply using actual samples of interest in a trial-and-error fashion and manually adjusting settings until results agree. This is not only time consuming, but also impractical for rare samples or low event-rate populations.

Some embodiments of the present disclosure address the foregoing challenges using a “ScatterGrid” or a “ScatterBridge,” each defined herein as multi-population signal output plots for cytometric control, reference and calibration. ScatterGrid and ScatterBridge can be generated using a collection of reagents, including hydrogel particles having distinct optical properties (e.g., combinations of multiple different levels of FSC and SSC) because of their composition and/or size. A single ScatterGrid or ScatterBridge can include representations of multiple different levels (e.g., high, medium, and low) of forward scatter signal output and representations of multiple different levels (e.g., high, medium, and low) of side scatter signal output, within a common plot.

In some embodiments, a ScatterGrid or ScatterBridge includes a plurality of scattering populations (i.e., groupings of scatter-related data/data points). For example, in some implementations, a ScatterGrid or ScatterBridge consists of nine unique, equally spaced signal scattering populations that are generated in a single flow cytometer acquisition run. When a lab operator takes a ScatterGrid or ScatterBridge measurement on a flow cytometer, they will register/detect, as a result of a single acquisition run, a signal matrix (e.g., a 3×3 signal matrix) output that includes a recorded low, medium, and high signal output for each of forward scattering and side scattering.

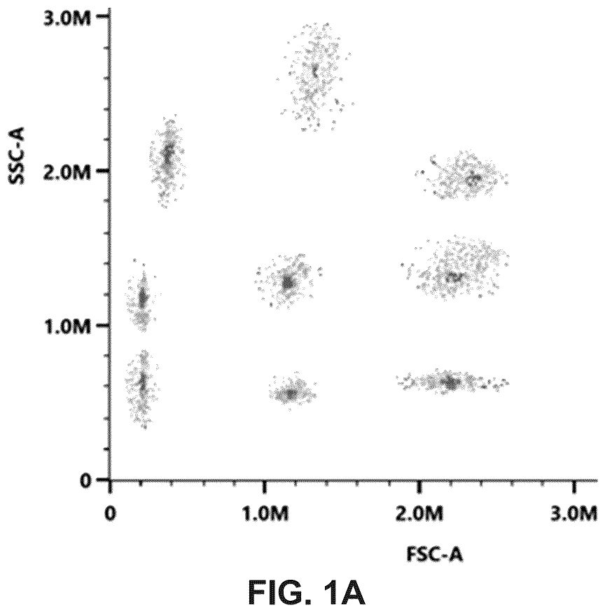

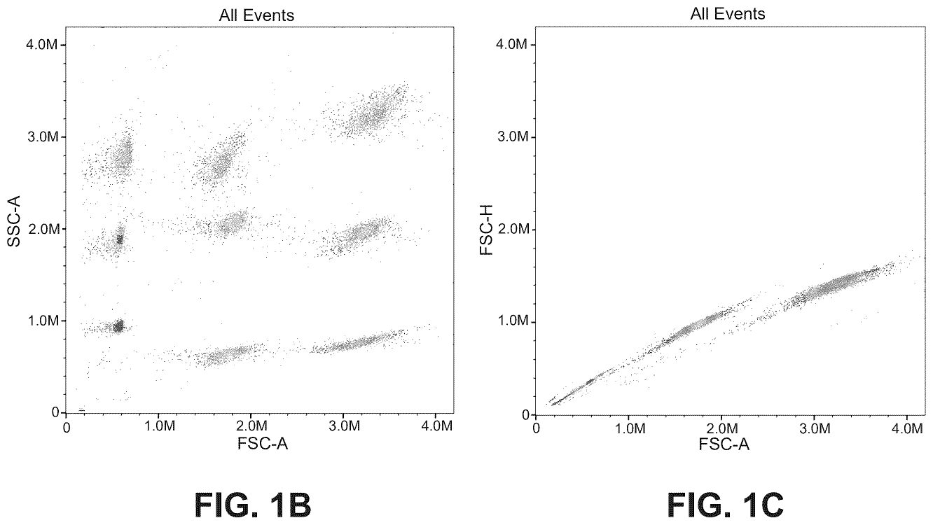

FIGS. 1A-1B are plots of flow cytometer data showing forward scatter-area (FSC-A) versus side scatter-area (SSC-A) and FIG. 1C is a plot of flow cytometer data showing FSC-A versus FSC-H. Each of FIG. 1A and FIG. 1B show nine unique signal populations (sets of sub-selected data points) in a single ScatterBridge, according to some embodiments. FIG. 1C shows three unique signal populations (sets of sub-selected data points) from the ScatterBridge. To achieve the variation in SSC, a nanoparticle loading in the formulation was varied. To achieve the variation in FSC, the monomer/crosslinker ratio and the size of the hydrogel particles (and, optionally, the size of the microfluidic channel) was varied. Although shown in FIGS. 1A and 1B as including nine signal populations in a 3×3 signal matrix, a variety of other numbers of signal populations and matrix dimensions are also contemplated (e.g., signal populations of two, three, four, five, six, seven, eight, ten, twelve, twenty, twenty-four, etc.; matrix dimensions of 1×2, 1×3, 2×2, 4×1, 1×5, 2×3, 1×6, 1×7, 2×, 1×8, 2×5, 1×10, 2×6, 3×4, 1×12, 5×4, 6×4, etc.).

In some embodiments, variation in SSC is achieved via the inclusion of nanoparticles in the hydrogel particles (or hydrogel particle formulations), including proteins in the hydrogel particles (or hydrogel particle formulations), and/or via porosity of the hydrogel particles in a particle formulations. Alternatively, or in addition, variation in FSC is achieved via tuning of gel fraction/polymer content of hydrogel particles. Alternatively, or in addition, one or more fluorophores, nucleic acids, functional groups and/or biomarkers can be added to the hydrogel particles (or hydrogel particle formulations) as applicable for a desired application.

In some embodiments, a hydrogel particle of the present disclosure comprises a material comprising a macromolecular three-dimensional network that allows it to swell when in the presence of water, to shrink in the absence of (or by reduction of the amount of) water, but not dissolve in water. The swelling, i.e., the absorption of water, is a consequence of the presence of hydrophilic functional groups attached to or dispersed within the macromolecular network. Crosslinks between adjacent macromolecules result in the aqueous insolubility of these hydrogels. The cross-links may be due to chemical (i.e., covalent) or physical (i.e., VanDer Waal forces, hydrogen-bonding, ionic forces, etc.) bonds. Synthetically prepared hydrogels can be prepared by polymerizing a monomeric material to form a backbone and cross-linking the backbone with a crosslinking agent. A characteristic of a hydrogel that is of particular value is that the material retains the general shape, whether dehydrated or hydrated. Thus, if the hydrogel has an approximately spherical shape in the dehydrated condition, it will be spherical in the hydrated condition.

In one embodiment, a hydrogel particle disclosed herein comprises greater than about 30%, greater than about 40%, greater than about 50%, greater than about 55%, greater than about 60%, greater than about 65%, greater than about 70%, greater than about 75%, greater than about 80%, greater than about 85%, greater than about 90%, or greater than about 95% water. In another embodiment, a hydrogel particle has a water content of about 10 percent by weight to about 95 percent by weight, or about 20 percent by weight to about 95 percent by weight, or about 30 percent by weight to about 95 percent by weight, or about 40 percent by weight to about 95 percent by weight, or about 50 percent by weight to about 95 percent by weight, or about 60 percent by weight to about 95 percent by weight, or about 70 percent by weight to about 95 percent by weight, or about 80 percent by weight to about 95 percent by weight.

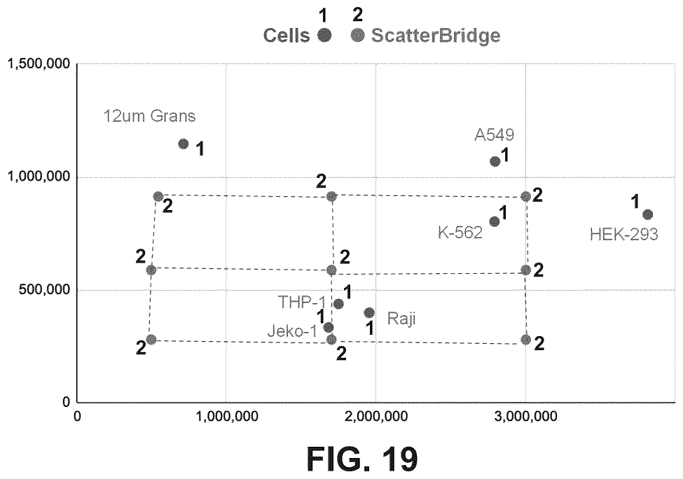

In one embodiment, the hydrogel particle has one or more optical properties substantially similar to the optical properties of one or more target cells. For instance, the hydrogel particle may have optical properties of one or more of a peripheral blood mononuclear cells, CAR-T cells, and THP-1 cells, though it should be appreciated that any biological cell type and disease may be referenced in determining the ScatterGrid or ScatterBridge to be used. In one embodiment, the hydrogel particle has pre-determined optical properties. The optical property, in one embodiment, is SSC, FSC, fluorescence emission, or a combination thereof. A relationship between exemplary biological cells and ScatterBridge is shown in FIG. 19, demonstrating that the system described herein is tunable to accommodate a variety of biological cell types. Table 1 includes exemplary cell mimics and biological cells.

TABLE 1
Cell Mimics and Biological Cells.

| | Diameter | |
|---|---|---|
| Cell | size (μm) | Project |
| Megakaryoblasts | 10 | Cell Mimic |
| T cell | 12 | Cell Mimic |
| Jurkat | 12 | Cell Mimic |
| Dendritic cells | 15 | Cell Mimic |
| Lymphocyte | 15 | Cell Mimic |
| corneal endothelial cells | 20 | Cell Mimic |
| Monos | 10 | Biological Cell |
| Jeko-1 B-Cell (Leukemia) | 13 | Biological Cell |
| THP-1 (monocyte cell) | 14 | Biological Cell |
| Raji B cell (Lymphoma) | 15 | Biological Cell |
| K-562 (leukemia lymphoblast) | 17 | Biological Cell |
| HEK-293 kidney epithelial | 17 | Biological Cell |
| A549 Lung Cancer) | 19 | Biological Cell |

In one embodiment, the hydrogel particles are synthesized by polymerizing one or more of the monomers provided herein. The synthesis is carried out to form individual hydrogel particles. The monomeric material (monomer) in one embodiment is polymerized to form a homopolymer. However, in another embodiment copolymers of different monomeric units (i.e., co-monomers) are synthesized and used in the methods provided herein. The monomer or co-monomers used in the methods and compositions described herein, in one embodiment, is a bifunctional monomer or includes a bifunctional monomer (where co-monomers are employed). In one embodiment, the hydrogel particle is synthesized in the presence of a crosslinker. In a further embodiment, embodiment, the hydrogel particle is synthesized in the presence of a polymerization initiator. The amount of monomer can be varied by the user to, for example, obtain a particular optical property that is substantially similar to that of a target cell. In one embodiment, the monomeric component(s) (i.e., monomer, co-monomer, bifunctional monomer, or a combination thereof, for example, bis/acrylamide in various crosslinking ratios, allyl amine or other co-monomers which provide chemical functionality for secondary labeling/conjugation or alginate is present at about 10 percent by weight to about 95 percent weight of the hydrogel particle. In a further embodiment, the monomeric component(s) is present at about 15 percent by weight to about 90 percent weight of the hydrogel particle, or about 20 percent by weight to about 90 percent weight of the hydrogel particle.

Examples of various monomers and cross-linking chemistries available for use with the present invention are provided in the Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf, the disclosure of which is incorporated by reference in its entirety for all purposes. For example, hydrazine (e.g., with an NHS ester compound) or EDC coupling reactions (e.g., with a maleimide compound) can be used to construct the hydrogel particles of the invention.

In one embodiment, a monomer for use with the hydrogel particles provided herein is lactic acid, glycolic acid, acrylic acid, 1-hydroxyethyl methacrylate, ethyl methacrylate, 2-hydroxyethyl methacrylate (HEMA), propylene glycol methacrylate, acrylamide, N-vinylpyrrolidone (NVP), methyl methacrylate, glycidyl methacrylate, glycerol methacrylate (GMA), glycol methacrylate, ethylene glycol, fumaric acid, a derivatized version thereof, or a combination thereof. In one embodiment, one or more of the following monomers is used herein to form a hydrogel particle of the present disclosure: 2-hydroxyethyl methacrylate, hydroxyethoxyethyl methacrylate, hydroxydiethoxyethyl methacrylate, methoxyethyl methacrylate, methoxyethoxyethyl methacrylate, methoxydiethoxyethyl methacrylate, poly(ethylene glycol) methacrylate, methoxy-poly(ethylene glycol) methacrylate, methacrylic acid, sodium methacrylate, glycerol methacrylate, hydroxypropyl methacrylate, hydroxybutyl methacrylate or a combination thereof.

In another embodiment, one or more of the following monomers is used herein to form a tunable hydrogel particle: phenyl acylate, phenyl methacrylate, benzyl acylate, benzyl methacrylate, 2-phenylethyl acrylate, 2-phenylethyl methacrylate, 2-phenoxyethyl acrylate, 2-phenoxyethyl methacrylate, phenylthioethyl acrylate, phenylthioethyl methacrylate, 2,4,6-tribromophenyl acrylate, 2,4,6-tribromophenyl methacrylate, pentabromophenyl acrylate, pentabromophenyl methacrylate, pentachlorophenyl acrylate, pentachlorophenyl methacrylate, 2,3-dibromopropyl acrylate, 2,3-dibromopropyl methacrylate, 2-naphthyl acrylate, 2-naphthyl methacrylate, 4-methoxybenzyl acrylate, 4-methoxybenzyl methacrylate, 2-benzyloxyethyl acrylate, 2-benzyloxyethyl methacrylate, 4-chlorophenoxyethyl acrylate, 4-chlorophenoxyethyl methacrylate, 2-phenoxyethoxyethyl acrylate, 2-phenoxyethoxyethyl methacrylate, N-phenyl acrylamide, N-phenyl methacrylamide, N-benzyl acrylamide, N-benzyl methacrylamide, N,N-dibenzyl acrylamide, N,N-dibenzyl methacrylamide, N-diphenylmethyl acrylamide N-(4-methylphenyl)methyl acrylamide, N-1-naphthyl acrylamide, N-4-nitrophenyl acrylamide, N-(2-phenylethyl)acrylamide, N-triphenylmethyl acrylamide, N-(4-hydroxyphenyl)acrylamide, N,N-methylphenyl acrylamide, N,N-phenyl phenylethyl acrylamide, N-diphenylmethyl methacrylamide, N-(4-methyl phenyl)methyl methacrylamide, N-1-naphthyl methacrylamide, N-4-nitrophenyl methacrylamide, N-(2-phenylethyl)methacrylamide, N-triphenylmethyl methacrylamide, N-(4-hydroxyphenyl)methacrylamide, N,N-methylphenyl methacrylamide, N,N′-phenyl phenylethyl methacrylamide, N-vinylcarbazole, 4-vinylpyridine, and 2-vinylpyridine.

Both synthetic monomers and bio-monomers can be used in the hydrogel particles provided herein, to form synthetic hydrogels, bio-hydrogels, or hybrid hydrogels that comprise a synthetic component and a bio-component (e.g., peptide, protein, monosaccharide, disaccharide, polysaccharide, primary amines sulfhydryls, carbonyls, carbohydrates, carboxylic acids present on a biomolecule). For example, proteins, peptides or carbohydrates can be used as individual monomers to form a hydrogel that includes or does not include a synthetic monomer (or polymer) and in combination with chemically compatible co-monomers and crosslinking chemistries (see for example, the Thermo Scientific Crosslinking Technical Handbook entitled “Easy molecular bonding crosslinking technology,” available at tools.lifetechnologies.com/content/sfs/brochures/1602163-Crosslinking-Reagents-Handbook.pdf, the disclosure of which is incorporated by reference in its entirety for all purposes.). Compatible crosslinking chemistries include, but are not limited to, amines, carboxyls, and other reactive chemical side groups.

In general, any form of polymerization chemistry/methods commonly known by those skilled in the art, can be employed to form polymers. In some embodiments, polymerization can be catalyzed by ultraviolet light-induced radical formation and reaction progression. In other embodiments, a hydrogel particle of the disclosure is produced by the polymerization of acrylamide or the polymerization of acrylate. For example, the acrylamide in one embodiment is a polymerizable carbohydrate derivatized acrylamide. Specific attachment of acrylamide groups to sugars is readily adapted to a range of monosaccharides and higher order polysaccharides, e.g., synthetic polysaccharides or polysaccharides derived from natural sources, such as glycoproteins found in serum or tissues.

In some embodiments, a hydrogel particle comprises a monofunctional monomer polymerized with at least one bifunctional monomer. One example includes, but is not limited to, the formation of poly-acrylamide polymers using acrylamide and bis-acrylamide (a bifunctional monomer). In another embodiment, a hydrogel particle provided herein comprises a bifunctional monomer polymerized with a second bifunctional monomer. One example includes, but is not limited to, the formation of polymers with mixed composition containing compatible chemistries such as acrylamide, bis-acrylamide, and bis-acrylamide structural congeners containing a wide range of additional chemistries. The range of chemically compatible monomers, bifunctional monomers, and mixed compositions is obvious to those skilled in the art and follows chemical reactivity principles know to those skilled in the art. (reference Thermo handbook and acrylamide polymerization handbook). See, for example, the Thermo Scientific Crosslinking Technical Handbook entitled “Easy molecular bonding crosslinking technology,” (available at tools.lifetechnologies.com/ntent/sfs/brochures/1602163-Crosslinking-Reagents-Handbook.pdf) and the Polyacrylamide Emulsions Handbook (SNF Floerger, available at snf.com.au/downloads/Emulsion_Handbook E.pdf), the disclosure of each of which is incorporated by reference in its entirety for all purposes.

In one embodiment, a hydrogel particle provided herein comprises a polymerizable monofunctional monomer and is a monofunctional acrylic monomer. Non-limiting examples of monofunctional acrylic monomers for use herein are acrylamide; methacrylamide; N-alkylacrylamides such as N-ethylacrylamide, N-isopropylacrylamide or N-tertbutyl acrylamide; N-alkylmethacrylamides such as N-ethylmethacrylamide or N-isopropylmethacrylamide; N,N-dialkylacrylamides such as N,N-dimethylacrylamide and N,N-diethyl-acrylamide; N-[(dialkylamino)alkyl]acrylamides such as N-[3dimethylamino) propyl]acrylamide or N-[3-(diethylamino)propyl]acrylamide; N-[(dialkylamino) alkyl]methacrylamides such as N-[3-dimethylamino)propyl]methacrylamide or N-[3-(diethylamino) propyl]methacrylamide; (dialkylamino)alkyl acrylates such as 2-(dimethylamino)ethyl acylate, 2-(dimethylamino)propyl acrylate, or 2-(diethylamino)ethyl acylates; and (dialkylamino) alkyl methacrylates such as 2-(dimethylamino) ethyl methacrylate.

A bifunctional monomer is any monomer that can polymerize with a monofunctional monomer of the disclosure to form a hydrogel as described herein that further contains a second functional group that can participate in a second reaction, e.g., conjugation of a fluorophore or cell surface receptor (or domain thereof).

In some embodiments, a bifunctional monomer is selected from the group consisting of: allyl amine, allyl alcohol, allyl isothiocyanate, allyl chloride, and allyl maleimide.

A bifunctional monomer can be a bifunctional acrylic monomer. Non-limiting examples of bifunctional acrylic monomers are N,N′-methylenebisacrylamide, N,N′methylene bismethacrylamide, N,N′-ethylene bisacrylamide, N,N′-ethylene bismethacrylamide, N,N′propylenebisacrylamide and N,N′-(1,2-dihydroxyethylene) bisacrylamide.

Higher-order branched chain and linear co-monomers can be substituted in the polymer mix to adjust the refractive index while maintaining polymer density. In some embodiments, a hydrogel particle comprises a molecule that modulates the optical properties of the hydrogel. Molecules capable of altering optical properties of a hydrogel are discussed further below.

In one embodiment, an individual hydrogel particle or a plurality thereof comprises a biodegradable polymer as a hydrogel monomer. In one embodiment, the biodegradable polymer is a poly(esters) based on polylactide (PLA), polyglycolide (PGA), polycaprolactone (PCL), and their copolymers. In one embodiment, the biodegradable polymer is a carbohydrate or a protein, or a combination thereof. For example, in one embodiment, a monosaccharide, disaccharide or polysaccharide, (e.g., glucose, sucrose, or maltodextrin) peptide, protein (or domain thereof) is used as a hydrogel monomer. Other biodegradable polymers include poly(hydroxyalkanoate)s of the PHB-PHV class, additional poly(ester)s, and natural polymers, for example, modified poly(saccharide)s, e.g., starch, cellulose, and chitosan. In another embodiment, the biocompatible polymer is an adhesion protein, cellulose, a carbohydrate, a starch (e.g., maltodextrin, 2-hydroxyethyl starch, alginic acid), a dextran, a lignin, a polyaminoacid, an amino acid, or chitin. Such biodegradable polymers are available commercially, for example, from Sigma Aldrich (St. Louis, Mo.).

The biomonomer, in one embodiment, is functionalized with acrylamide or acrylate. For example, in one embodiment, the polymerizable acrylamide functionalized biomolecule is an acrylamide or acrylate functionalized protein (for example, an acrylamide functionalized collagen or functionalized collagen domain), an acrylamide or acrylate functionalized peptide, or an acrylamide or acrylate functionalized monosaccharide, disaccharide or polysaccharide.

Any monosaccharide, disaccharide or polysaccharide (functionalized or otherwise) can be used as a hydrogel monomer. In one embodiment, an acrylamide or acrylate functionalized monosaccharide, disaccharide or polysaccharide is used as a polymerizable hydrogel monomer. In one embodiment, a structural polysaccharide is used as a polymerizable hydrogel monomer. In a further embodiment, the structural polysaccharide is an arabinoxylan, cellulose, chitin or a pectin. In another embodiment, alginic acid (alginate) is used as a polymerizable hydrogel monomer. In yet another embodiment, a glycosaminoglycan (GAG) is used as a polymerizable monomer in the hydrogels provided herein. In a further embodiment, the GAG is chondroitin sulfate, dermatan sulfate, keratin sulfate, heparin, heparin sulfate or hyaluronic acid (also referred to in the art as hyaluron or hyaluronate) is used as a polymerizable hydrogel monomer. The additional range of compatible biomonomers and their reactive chemistries are known be individuals skilled in the art and follow general chemical reactivity principles.

Naturally occurring hydrogels include various polysaccharides available from natural sources such as plants, algae, fungi, yeasts, marine invertebrates and arthropods. Non-limiting examples include agarose, dextrans, chitin, cellulose-based compounds, starch, derivatized starch, and the like. These generally will have repeating glucose units as a major portion of the polysaccharide backbone. Cross-linking chemistries for such polysaccharides are known in the art, see for example Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf).

Hyaluronan in one embodiment is used as a hydrogel monomer (either as a single monomer or as a co-monomer). Hyaluronan in one embodiment, is functionalized, for example with acrylate or acrylamide. Hyaluronan is a high molecular weight GAG composed of disaccharide repeating units of N-acetylglucosamine and glucuronic acid linked together through alternating β-1,4 and β-1,3 glycosidic bonds. In the human body, hyaluronate is found in several soft connective tissues, including skin, umbilical cord, synovial fluid, and vitreous humor. Accordingly, in one embodiment, where one or more optical properties of a skin cell, umbilical cord cell or vitreous humor cell is desired to be mimicked, in one embodiment, hyaluronan is used as a hydrogel monomer. Hyaluronan can be derivatized with various reactive handles depending on the desired cross-linking chemistry and other monomers used to form a hydrogel particle.

In yet other embodiments, chitosan, a linear polysaccharide composed of randomly distributed β-(1-4)-linked D-glucosamine (deacetylated unit) and N-acetyl-D-glucosamine (acetylated unit), is used as a hydrogel monomer (either as a single monomer or as a co-monomer).

Other polysaccharides for use as a hydrogel monomer or co-monomer include but are not limited to, agar, agarose, alginic acid, alguronic acid, alpha glucan, amylopectin, amylose, arabinoxylan, beta-glucan, callose, capsullan, carrageenan polysaccharides (e.g., kappa, iota or lambda class), cellodextrin, cellulin, cellulose, chitin, chitosan, chrysolaminarin, curdlan, cyclodextrin, alpha-cyclodextrin, dextrin, ficoll, fructan, fucoidan, galactoglucomannan, galactomannan, galactosaminogalactan, gellan gum, glucan, glucomannan, glucuronoxylan, glycocalyx, glycogen, hemicellulose, homopolysaccharide, hypromellose, icodextrin, inulin, kefiran, laminarin, lentinan, levan polysaccharide, lichenin, mannan, mixed-linkage glucan, paramylon, pectic acid, pectin, pentastarch, phytoglycogen, pleuran, polydextrose, polysaccharide peptide, porphyran, pullulan, schizophyllan, sinistrin, sizofiran, welan gum, xanthan gum, xylan, xyloglucan, zymosan, or a combination thereof. As described throughout, depending on the desired cross-linking chemistry and/or additional co-monomers employed in the hydrogel, the polysaccharide can be further functionalized. For example, one or more of the polysaccharides described herein in one embodiment is functionalized with acrylate or acrylamide.

In one embodiment, an individual hydrogel particle or a plurality thereof comprises a peptide, protein, a protein domain, or a combination thereof as a hydrogel monomer or plurality thereof. In a further embodiment, the protein is a structural protein, or a domain thereof, for example, such as silk, elastin, titin or collagen, or a domain thereof. In one embodiment, the protein is an extracellular matrix (ECM) component (e.g., collagen, elastin, proteoglycan). In even a further embodiment, the structural protein is collagen. In yet a further embodiment, the collagen is collagen type I, collagen type II or collagen type III or a combination thereof. In another embodiment, the hydrogel monomer comprises a proteoglycan. In a further embodiment, the proteoglycan is decorin, biglycan, testican, bikunin, fibromodulin, lumican, or a domain thereof.

In another embodiment, an acrylate-functionalized structural protein hydrogel monomer is used as a component of the hydrogel provided herein (e.g., an acrylate functionalized protein or protein domain, for example, silk, elastin, titin, collagen, proteoglycan, or a functionalized domain thereof). In a further embodiment, the acrylate functionalized structural protein hydrogel monomer comprises a proteoglycan, e.g., decorin, biglycan, testican, bikunin, fibromodulin, lumican, or a domain thereof.

In one embodiment PEG monomers and oligopeptides can be that mimic extracellular matrix proteins are used in the hydrogels provided herein, for example, with vinyl sulfone-functionalized multiarm PEG, integrin binding peptides and bis-cysteine matrix metalloproteinase peptides. In this particular embodiment, hydrogels are formed by a Michael-type addition reaction between the di-thiolated oligopeptides and vinyl sulfone groups on the PEG. The range of additional compatible chemistries that can be incorporated here are obvious to those skilled in the art and follow general chemical reactivity principles, see for example Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf).

Other bioactive domains in natural proteins can also be used as a hydrogel monomer or portion thereof. For example, a cell-adhesive integrin binding domain, a controlled release affinity binding domain or a transglutaminase cross-linking domain can be used in the hydrogels provided herein.

In one embodiment, recombinant DNA methods are used to create proteins, designed to gel in response to changes in pH or temperature. Briefly, the proteins consist of terminal leucine zipper domains flanking a water-soluble polyelectrolyte segment. In near-neutral aqueous solutions, coiled-coil aggregates of the terminal domains form a three-dimensional hydrogel polymer network.

Common cross-linking agents that can be used to crosslink the hydrogels provided herein include but are not limited to ethylene glycol dimethacrylate (EGDMA), tetraethylene glycol dimethacrylate, and N,N′-15 methylenebisacrylamide. The range of additional crosslinking chemistries which can be used are obvious to those skilled in the art and follow general chemical reactivity principles, see for example Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf).

In one embodiment, polymerization of a hydrogel is initiated by a persulfate or an equivalent initiator that catalyzes radical formation. The range of compatible initiators are known to those skilled in the art and follow general chemical reactivity principles, see for example Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf). The persulfate can be any water-soluble persulfate. Non-limiting examples of water-soluble persulfates are ammonium persulfate and alkali metal persulfates. Alkali metals include lithium, sodium, and potassium. In some embodiments, the persulfate is ammonium persulfate or potassium persulfate. In a further embodiment, polymerization of the hydrogel provided herein is initiated by ammonium persulfate.

Polymerization of a hydrogel can be accelerated by an accelerant which can catalyze the formation of polymerization-labile chemical side groups. The range of possible accelerants is known to those skilled in the art and follow general chemical reactivity principles see for example Thermo Scientific Crosslinking Technical Handbook entitled “Easy molecular bonding crosslinking technology,” (available at tools.lifetechnologies.com/content/sfs/brochures/1602163-Crosslinking-Reagents-Handbook.pdf). The accelerant in one embodiment, is a tertiary amine. The tertiary amine can be any water-soluble tertiary amine. In one embodiment, an accelerant is used in the polymerization reaction and is N,N,N′,N′tetramethylethylenediamine, 3-dimethylamino) propionitrile, or N,N,N′,N′tetramethylethylenediamine (TEMED). In another embodiment, an accelerant is used in the polymerization reaction and isazobis (isobutyronitrile) (AIBN).

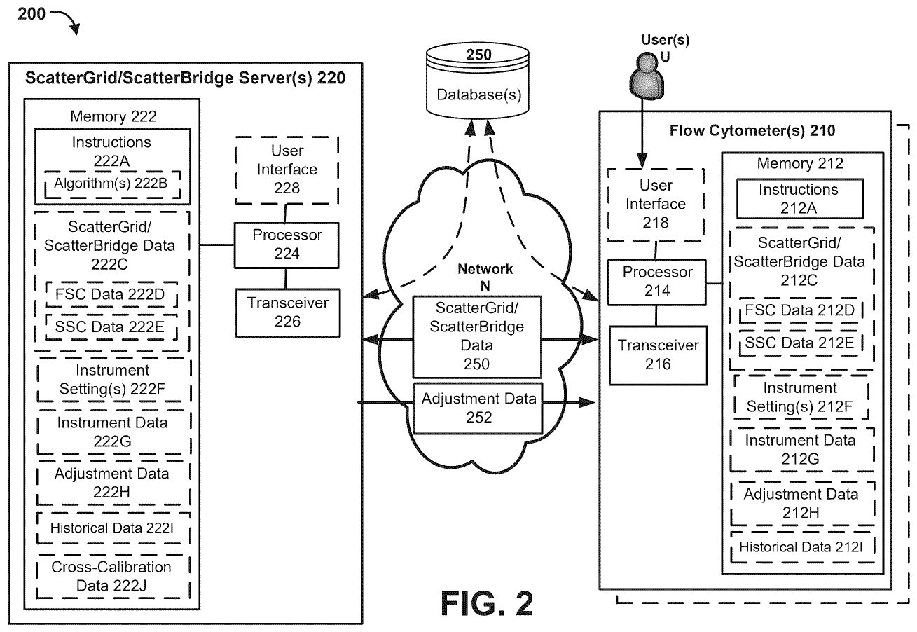

As discussed above, the hydrogel for use in the compositions and methods described herein can include any of the monomeric units and crosslinkers as described herein, and in one aspect, are produced as hydrogel particles by polymerizing droplets (see, e.g., FIG. 2). Microfluidic methods of producing a plurality of droplets, including fluidic and rigidified droplets, are known to those of ordinary skill in the art. Such methods provide for a plurality of droplets containing a first fluid and being substantially surrounded by a second fluid, where the first fluid and the second fluid are substantially immiscible (e.g., droplets containing an aqueous-based liquid being substantially surrounded by an oil-based liquid).

A plurality of fluidic droplets (e.g., prepared using a microfluidic device) may be polydisperse (e.g., having a range of different sizes), or in some cases, the fluidic droplets may be monodisperse or substantially monodisperse, e.g., having a homogenous distribution of diameters, for instance, such that no more than about 10%, about 5%, about 3%, about 1%, about 0.03%, or about 0.01% of the droplets have an average diameter greater than about 10%, about 5%, about 3%, about 1%, about 0.03%, or about 0.01% of the average diameter. The average diameter of a population of droplets, as used herein, refers to the arithmetic average of the diameters of the droplets. Average diameters of the particles can be measured, for example, by light scattering techniques. Average diameters of hydrogel particles in one embodiment, are tailored, for example by varying flow rates of the fluid streams of the first and second fluids within the channel(s) of a microfluidic device, or by varying the volume of the channel(s) of the microfluidic device. A micro fluidic device comprising a micro fluidic channel is especially well suited to preparing a plurality of mono disperse droplets.

Accordingly, the disclosure provides a population of hydrogel particles comprising a plurality of hydrogel particles, wherein the population of hydrogel particles is substantially monodisperse.

Droplet size is related to microfluidic channel size. The micro fluidic channel may be of any size, for example, having a largest dimension perpendicular to fluid flow of less than about 5 mm or 2 mm, or less than about 1 mm, or less than about 500 μm, less than about 200 μm, less than about 100 μm, less than about 60 μm, less than about 50 μm, less than about 40 μm, less than about 30 μm, less than about 25 μm, less than about 10 μm, less than about 3 μm, less than about 1 μm, less than about 300 nm, less than about 100 nm, less than about 30 nm, or less than about 10 nm.

Droplet size can be tuned by adjusting the relative flow rates. In some embodiments, drop diameters are equivalent to the width of the channel, or within about 10%, 15%, 20%, 30%, 40%, 50%, 60%, 70%, 80%, 90%, or 100% the width of the channel.

The dimensions of a hydrogel particle of the disclosure are substantially similar to the droplet from which it was formed. Therefore, in some embodiments, a hydrogel particle has a diameter of less than about 1 μm, 2, 5, 10, 15, 20, 25, 30, 35, 40, 45, 50, 60, 70, 80, 90, 100, 120, 150, 200, 250, 300, 350, 400, 450, 500, 600, 800, or less than 1000 μm in diameter. In some embodiments, a hydrogel particle has a diameter of more than about 1 μm, 2, 5, 10, 15, 20, 25, 30, 35, 40, 45, 50, 60, 70, 80, 90, 100, 120, 150, 200, 250, 300, 350, 400, 450, 500, 600, 800, or greater than 1000 μm in diameter. In one embodiment, a hydrogel particle has a diameter in the range of 5 μm to 100 μm.

In some embodiments, a hydrogel particle of the disclosure is spherical in shape.

Hydrogel particles in one embodiment, is carried by suspension polymerization, which is also referred to in the art as pearl, bead, or granular polymerization. In suspension polymerization, the monomer is insoluble in the continuous phase, for example an aqueous monomer solution in a continuous oil phase. In suspension polymerization, polymerization initiation occurs within the monomer-rich droplets and with greater than one radical per droplet at any time. The monomer phase in one embodiment includes a monomer which can be a bifunctional monomer or a plurality of monomer species (co-monomers, which can be a plurality of bifunctional monomers. The monomer phase in one embodiment, includes an initiator and/or a crosslinking agent.

Emulsion polymerization can also be used to form the hydrogel particles described herein. In emulsion polymerization, the monomer has poor solubility in the continuous phase, similar to suspension polymerization, however, polymerization initiation occurs outside the monomer droplets. In emulsion polymerization embodiments, the initiator causes chain growth of the monomer (or co-monomers) dissolved in the continuous phase or monomer contained in micelles if surfactants are present.

In another embodiment, hydrogel particles are formed by precipitation polymerization. Precipitation polymerization is a technique that takes advantage of the differences in the solubility of monomer and polymer to produce microparticles. Specifically, it is known that larger polymer chains generally have lower solubility than smaller ones. Accordingly, above a specific molecular weight, phase separation may be favored. Precipitation polymerization initially begins as solution polymerizations in a single phase, homogenous system. Shortly after the start of the polymerization, in one embodiment, a relatively high concentration of polymer chains is present, favoring phase separation by nucleation. As polymerization proceeds, the concentration of polymer chains is low and existing particles capture the chains before nucleation of new particles can occur. Thus, nucleation of particles occurs only for a brief period of time shortly after the start of the reaction, which in one embodiment, results in a narrow size distribution of particles. Additional methods include but are not limited to lithographic particle formation, membrane emulsification, and microchannel emulsification, and bulk emulsification.

In one embodiment, hydrogel particles are formed within a microfluidic device having two oil channels that focus on a central stream of aqueous monomer solution. In this embodiment, droplets form at the interface of the two channels and central stream to break off droplets in water-in-oil emulsion. Once droplets are formed, in one embodiment, they are stabilized prior to polymerization, for example, by adding a surfactant to the oil phase. However, in another embodiment, droplets are not stabilized prior to polymerization. Polymerization of the monomer in one embodiment is triggered by adding an accelerator (e.g., N,N,N′,N′tetramethylethylenediamine) to one or both of the oil channels after initial droplets are formed.

The aqueous monomer solution as provided above can include a single monomer species or a plurality of monomer species. The aqueous monomer solution can include co-monomers, a bifunctional monomer, or a combination thereof. In one embodiment, the monomer or plurality of monomers can includes a bifunctional monomer, for example, one of the monomers described above. As described below, co-monomers can be used to modulate forward scatter or side scatter, for example, by adjusting the refractive index of the hydrogel particle.

In one embodiment, the central stream of aqueous monomer solution comprises a cross-linker, for example, N,N′-bisacrylamide. In a further embodiment, the central stream of aqueous monomer solution comprises a cross-linker and an accelerator, in addition to the monomer. In yet a further embodiment, the aqueous monomer solution comprises an initiator, for example an oxidizing agent such as ammonium persulfate.

In preparing the hydrogel particles of the ScatterGrid or ScatterBridge, forward scatter can be modulated by adjusting the refractive index of the gel by adding co-monomers allyl acrylate and allyl methacrylate. Forward scatter can also be modulated with side scattering nanoparticles containing sufficient optical resolution/size/density including, but not limited to, higher density colloidal suspensions of silica and/or PMMA particles. Side scattering of the droplets can be tuned by adding a colloidal suspension of silica nanoparticles and/or PMMA (poly(methyl methacrylate)) particles (e.g., ˜100 nm in diameter) to the central aqueous phase prior to polymerization.

In one embodiment, a bead, plurality of beads, biomolecule, or plurality of biomolecules is embedded (encapsulated) within the hydrogel particle. An encapsulated bead or biomolecule, in one embodiment, is employed to mimic one or more intracellular organelles of a target cell, or a cell after it engulfs a particle. In one embodiment, encapsulating or embedding a bead or biomolecule is accomplished at the time of hydrogel particle formation. For example, beads can be suspended in the appropriate concentration to allow for an average of one bead to be embedded/encapsulated in a single hydrogel particle. The bead suspension can be included, for example, within the aqueous solution of monomer. Similarly, a biomolecule or mixture of biomolecules can be incorporated into the aqueous solution of monomer to encapsulate the biomolecule or biomolecules.

Alternatively, once a hydrogel particle is formed, for example by the methods described above, in one embodiment, it can be further manipulated, for example, by embedding a bead, plurality of beads, biomolecule or plurality of biomolecules within the hydrogel particle. Accordingly, in one aspect of the invention, a hydrogel comprising an embedded substance is provided.

In one embodiment, the embedded substance is an embedded molecule, for example a biomolecule. The biomolecule can be a single species or a plurality of different species. For example, a protein, peptide, carbohydrate, nucleic acid, or combination thereof can be encapsulated within a hydrogel particle of the invention. Moreover, different nucleic acid molecules (e.g., of varying sequences or nucleic acid type such as genomic DNA, messenger RNA or DNA-RNA hybrids) can be encapsulated by the hydrogel particle of the invention. These can be comprised of any protein or nucleic acid as both forms of biological material contain labile chemical side-groups (or can be modified by commercial vendors (e.g., Integrated DNA Technology chemical side group modifications). Such side-groups are compatible with reaction chemistries commonly found in co-monomer compositions (e.g. acrylate chemistry, NHS-ester, primary amines, copper catalyzed click chemistry (Sharpless)). The range of possible embedded molecules which contain compatible chemistries is understood by those skilled in the art.

In one embodiment, as may be the case for implementation within ScatterGrid or ScatterBridge, different subpopulations of hydrogel particles are fabricated, each with a different concentration of biomolecule. In a further embodiment, the biomolecule is a nucleic acid, a protein, an intracellular ion such as calcium acid (or other biomolecule of the user's choosing, for example, calcium). In another embodiment, different subpopulations of hydrogel particles are fabricated, each with a different concentration of a drug substance. The drug substance in one embodiment is a biomolecule (i.e., a biologic, antibody, antibody drug conjugate, protein/enzyme, peptide, non-ribosomal peptide, or related molecule) or a small molecule synthetic drug (e.g., Type I/II/III polyketide, non-ribosomal peptide with bioactive properties, or other small molecule entity as generally classified by those skilled in the art).

In one embodiment, a bead with a diameter of about 1 μm to about 3 μm, about 2 μm to about 4 μm or about 3 μm to about 7 μm is embedded in a hydrogel provided herein. For example, in one embodiment, the bead has a diameter of about 3 μm to about 3.5 μm.

In one embodiment, the refractive index (RI) of a disclosed hydrogel particle is greater than about 1.10, greater than about 1.15, greater than about 1.20, greater than about 1.25, greater than about 1.30, greater than about 1.35, greater than about 1.40, greater than about 1.45, greater than about 1.50, greater than about 1.55, greater than about 1.60, greater than about 1.65, greater than about 1.70, greater than about 1.75, greater than about 1.80, greater than about 1.85, greater than about 1.90, greater than about 1.95, greater than about 2.00, greater than about 2.1 0, greater than about 2.20, greater than about 2.30, greater than about 2.40, greater than about 2.50, greater than about 2.60, greater than about 2.70, greater than about 2.80, or greater than about 2.90.

In another embodiment, the refractive index (RI) of a disclosed hydrogel particle is about 1.10 to about 3.0, or about 1.15 to about 3.0, or about 1.20 to about 3.0, or about 1.25 to about 3.0, or about 1.30 to about 3.0, or about 1.35 to about 3.0, or about 1.4 to about 3.0, or about 1.45 to about 3.0, or about 1.50 to about 3.0, or about 1.6 to about 3.0, or about 1.7 to about 3.0, or about 1.8 to about 3.0, or about 1.9 to about 3.0, or about 2.0 to about 3.0.

In some embodiments, the refractive index (RI) of a disclosed hydrogel particle is less than about 1.1 0, less than about 1.15, less than about 1.20, less than about 1.25, less than about 1.30, less than about 1.35, less than about 1.40, less than about 1.45, less than about 1.50, less than about 1.55, less than about 1.60, less than about 1.65, less than about 1.70, less than about 1.75, less than about 1.80, less than about 1.85, less than about 1.90, less than about 1.95, less than about 2.00, less than about 2.10, less than about 2.20, less than about 2.30, less than about 2.40, less than about 2.50, less than about 2.60, less than about 2.70, less than about 2.80, or less than about 2.90.

The SSC of a disclosed hydrogel particle is most meaningfully measured in comparison to that of target cell. In some embodiments, a disclosed hydrogel particle has an SSC within 30%, within 25%, within 20%, within 15%, within 10%, within 5%, or within 1% that of a target cell, as measured by a cytometric device.

The SSC of a hydrogel particle in one embodiment, is modulated by incorporating a high-refractive index molecule (or plurality thereof) in the hydrogel. In one embodiment, a high-refractive index molecule is provided in a hydrogel particle, and in a further embodiment, the high-refractive index molecule is colloidal silica, alkyl acrylate, alkyl methacrylate or a combination thereof. Thus, in some embodiments, a hydrogel particle of the disclosure comprises alkyl acrylate and/or alkyl methacrylate. Concentration of monomer in one embodiment is adjusted to further adjust the refractive index of the hydrogel particle.

Alkyl acrylates or Alkyl methacrylates can contain 1 to 18, 1 to 8, or 2 to 8, carbon atoms in the alkyl group, such as methyl, ethyl, n-propyl, isopropyl, n-butyl, isobutyl or tertbutyl, 2-ethylhexyl, heptyl or octyl groups. The alkyl group may be branched or linear.

High-refractive index molecules can also include vinylarenes such as styrene and methylstyrene, optionally substituted on the aromatic ring with an alkyl group, such as methyl, ethyl, or tert-butyl, or with a halogen, such as chlorostyrene.

In some embodiments, FSC is modulated by adjusting the percentage of monomer present in the composition thereby altering the water content present during hydrogel formation. In one embodiment, where a monomer and co-monomer are employed, the ratio of monomer and co-monomer is adjusted to change the hydrogel particle's forward scatter properties.

The FSC of a disclosed hydrogel particle is most meaningfully measured in comparison to that of target cell. In some embodiments, a disclosed hydrogel particle has an FSC within 30%, within 25%, within 20%, within 15%, within 10%, within 5%, or within 1% that of a target cell, as measured by a cytometric device.

FSC is related to particle volume, and thus can be modulated by altering particle diameter, as described herein. Generally, it has been observed that large objects refract more light than smaller objects leading to high forward scatter signals (and vice versa). Accordingly, particle diameter in one embodiment is altered to modulate FSC properties of a hydrogel particle. For example, hydrogel particle diameter is increased in one embodiment is altered by harnessing larger microfluidic channels during particle formation.

SSC can be engineered by encapsulating nanoparticles within hydrogels to mimic organelles in a target cell. In some embodiments, a hydrogel particle of the disclosure comprises one or more types of nanoparticles selected from the group consisting of: polymethyl methacrylate (PMMA) nanoparticles, polystyrene (PS) nanoparticles, and silica nanoparticles. Without wishing to be bound by theory, the ability to selectively tune both forward and side scatter of a hydrogel, as described herein, allows for a robust platform to mimic a vast array of cell types.

After the hydrogel particle is formed, one or more of the particle's surfaces can be functionalized, for example, to mimic one or more optical properties of a target cell or a labeled target cell. The functionalized hydrogel particle can also include an embedded bead or substance such as a biomolecule, as described above. In one embodiment, one or more hydrogel particles are functionalized with one or more fluorescent dyes, one or more cell surface markers (or epitope binding regions thereof), or a combination thereof. In one embodiment, the hydrogel particle is formed by polymerizing at least one bifunctional monomer and after formation, the hydrogel particle includes one or more functional groups that can be used for further attachment of a cell surface marker, an epitope binding region of a cell surface marker, a fluorescent dye, or combination thereof. The free functional group, in one embodiment, is an amine group, a carboxyl group, a hydroxyl group or a combination thereof. Depending on the functionalization desired, it is to be understood that multiple bifunctional monomers can be used, for example, to functionalize the particle using different chemistries and with different molecules.

Examples of hydrogel particles (optionally implemented as beads) compatible with embodiments of the present disclosure (e.g., for use in generating scatterplots via flow cytometer acquisition runs) can be found in U.S. Pat. No. 10,753,846, issued Aug. 25, 2020 and titled “Hydrogel Particles with Tunable Optical Properties and Methods for Using the Same,” the entire contents of which are incorporated by reference herein in their entirety for all purposes.

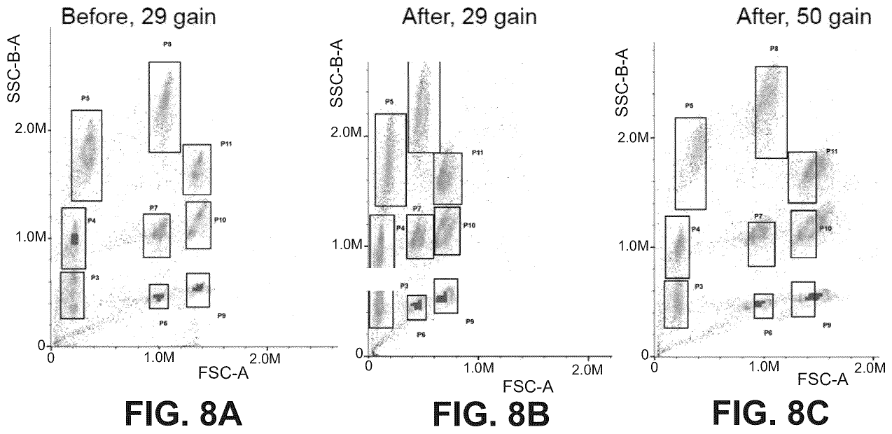

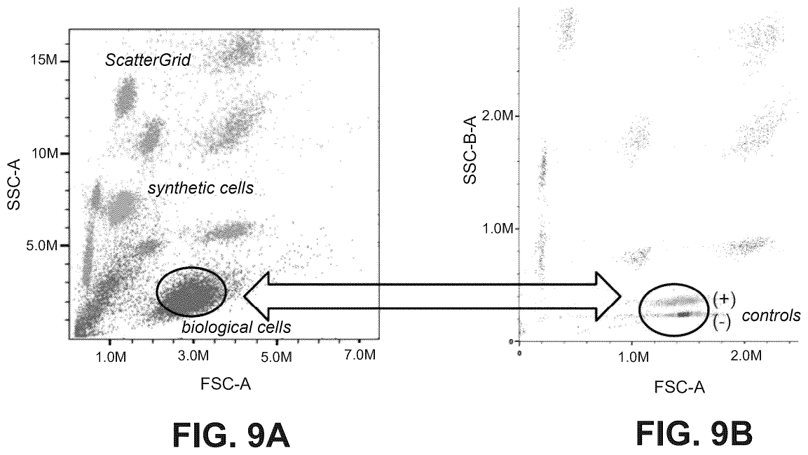

One or more embodiments of the present disclosure facilitate the product-based testing of multiple different flow cytometry instrument models and manufacturers, with different instrument settings, to calibrate the relative FSC and SSC signal responses among those instruments, using ScatterGrid or ScatterBridge. Although shown and described herein as pertaining to flow cytometers, use of ScatterGrid or ScatterBridge can also apply to any other instrument capable of generating multiple levels of FSC and/or SSC. Data (e.g., from day-to-day operations) can thus be normalized, and data acquisition can be standardized, across multiple flow cytometers/research entities, and flow cytometer performance and calibration can be monitored over time, e.g., overlapping in time or concurrently/simultaneously, for multiple flow cytometers. For example, research and development teams can mutually collaborate and/or reconcile their measurements using ScatterGrid or ScatterBridge data (e.g., using a ScatterGrid such as those shown and discussed below with reference to FIGS. 9A-9B), thereby accelerating research and development timelines. For example, in FIGS. 9A-9B discussed below, analysis of a biological sample in comparison to a ScatterGrid on a first flow cytometer was used to generate control populations of hydrogel particles with forward scatter and side scatter signals comparable to the biological sample, using ScatterGrid as a common reference, on a second flow cytometer. FIG. 8, discussed below, depicts the use of ScatterGrid to adjust gain settings after a flow cytometer was serviced.

One or more embodiments of the present disclosure offer several advantages over known flow cytometry processes. First, it is noted that the performance of flow cytometer instruments can naturally degrade over time, for example due to signal drift arising from wear and tear on the hardware. Using one or more ScatterGrid or ScatterBridge embodiments of the present disclosure, flow cytometry laboratory operators can monitor the performance of their flow cytometers for routine quality control purposes as well as for non-routine quality control purposes, such as periodic preventative maintenance. For example, when a flow cytometer engineer performs preventive maintenance, they may change the forward scatter, side scatter or fluorescence gain, or install a new excitation source or a new detector. As a result of these changes, the nominal instrument settings may need to be significantly re-adjusted, thereby interfering with a lab operator's routine workflow. By leveraging ScatterGrid or ScatterBridge data, lab operators can calibrate or adjust their instrument settings accordingly, e.g., based on an evaluation of the reported signal acquisition data, such as forward scatter and side scatter, of the ScatterGrid or ScatterBridge, apply adjustments to instrument settings accordingly, and continue their experiments with the adjusted flow cytometry settings. The foregoing can be achieved by testing a hydrogel particle formulation on the flow cytometer, which generates a signal data acquisition (e.g., a 3×3 ScatterGrid or ScatterBridge). More specifically, the ScatterGrid or ScatterBridge data can include low, medium, and high signal readouts for both side scattering and forward scattering, e.g., for instrument settings that are designed for routine biological cellular analysis. Lab operators in the field of biological cell analysis can thus ensure a linear response for their data acquisition measurements while reducing or eliminating the effects of noise (e.g., autofluorescence, mechanical vibrations, environmental electrical fields (for example, from AC power lines), etc.) without exceeding upper limits due to saturation (e.g., multiple photons being tabulated as single photons). As used herein, a “hydrogel particle formulation” can refer to a collection of hydrogel particles having discrete scatter signals that produce an array or matrix to optimize machine signal alignment.

Second, from an engineering perspective and with regard to the upstream manufacturer processes for flow cytometers, one or more embodiments of the present disclosure offer several advantages. For example, the manner in which individual hardware, firmware, and software components are manufactured and assembled may be standardized prior to being sold as flow cytometer units. To the inventors' knowledge, there does not exist a standardized method for assembling flow cytometer instruments from raw components, as evidenced by the wide variation in data analysis outcomes in cellular analysis. For example, there are different laser excitation sources with varying intensity, wavelength, and precision; different lenses, mirrors, filters, and collection angles for light processing; and different detectors (e.g., photomultiplier tubes, photodiodes, and/or charge coupled devices) having different quantum efficiencies across the electromagnetic spectrum which offer different signal processing capabilities.

Third, from a data science, machine learning, and bioinformatics perspective, one or more embodiments of the present disclosure can improve the way information is stored and processed for complex cellular acquisition analysis, such that statistical, mathematical, and probability analyses can be validated with high confidence across the side scattering and forward scattering regions in which cellular analysis is typically practiced on flow cytometers.

The hydrogel particles described herein can be employed in any flow cytometer known to those of ordinary skill in the art. For example, one or more of the flow cytometers provided in Table 2 and Table 3 below are amenable for use with the hydrogels and assays described herein.

TABLE 2
Exemplary instruments.

| Instrument | Manufacturer |
|---|---|
| MACSQuant ® Analyzer 10 | Miltenyi |
| MACSQuant ® VYB | Miltenyi |
| BD ® FACSCalibur ™ | BD ® Biosciences |
| BD ® FACSCanto ™ High | BD ® Biosciences |
| Throughput Sampler | |
| BD ® FACSCanto II | BD ® Biosciences |
| BD ® FACSCanto ™ | BD ® Biosciences |
| BD ® FACSCount ™ | BD ® Biosciences |
| BD ® Accuri ™ C6 | BD ® Biosciences |
| BD ® LSRFortessa ™ X-20 | BD ® Biosciences |
| BD ® FACSCanto ™ II | BD ® Biosciences |
| BD ® LSR II | BD ® Biosciences |
| BD ® LSRFortessa ™ | BD ® Biosciences |
| BD ® FACSVerse ™ | BD ® Biosciences |
| BD ® FACSAria ™ Fusion | BD ® Biosciences |
| BD ® FACSAria ™ | BD ® Biosciences |
| BD ® FACSAria ™ III | BD ® Biosciences |
| BD FACSJazz ™ | BD ® Biosciences |
| BD ® Influx ™ | BD ® Biosciences |
| Fortessa X50. | BD ® Biosciences |
| FlowSight Flow Cytometer | Millipore |
| Guava easyCyte 6-2L | Millipore |
| Benchtop Flow Cytometer | |
| guava easyCyte SHT Benchtop | Millipore |
| Flow Cytometer | |
| guava easyCyte 8 Benchtop | Millipore |
| Flow Cytometer | |
| guava easyCyte 5 Benchtop | Millipore |
| Flow Cytometer | |
| guava easyCyte 8HT Benchtop | Millipore |
| Flow Cytometer | |
| guava easyCyte 6HT-2L Benchtop | Millipore |
| Flow Cytometer | |
| ImageStreamX Mark II Imaging | Millipore |
| Flow Cytometer | |
| Muse Cell Analyzer | Millipore |
| guava easyCyte 12HT Benchtop | Millipore |
| Flow Cytometer | |
| guava easyCyte 12 Benchtop | Millipore |
| Flow Cytometer | |
| S3e ™ Cell Sorter | Bio-Rad |
| S3 ™ Cell Sorter | Bio-Rad |
| Avalon Cell Sorter | Bio-Rad/Propel Labs |
| CytoFLEX | Beckman Coulter |
| FP 1000 Cell Preparation System | Beckman Coulter |
| Vi-CELL ® XR Cell Viability Analyzer | Beckman Coulter |
| FC 500 Series | Beckman Coulter |
| MoFlo ® Astrios ™ | Beckman Coulter |
| Coulter Epics XL ™ and XL-MCL ™ | Beckman Coulter |
| Gallios ™ | Beckman Coulter |
| CyAn ™ ADP Analyzer | Beckman Coulter |
| Attune ™ Acoustic Focusing Cytometer | Life Technologies |
| Attune ® NxT Acoustic | Life Technologies |
| Focusing Cytometer | |
| EVOS | Life Technologies |
| Countess II FL | Life Technologies |
| EC800 Cell Analyzer | Sony |
| SH800 Cell Sorter | Sony |
| SP6800 Spectral Analyzer | Sony |
| SY3200 Cell Sorter | Sony |
| A50-Micro′ | Apogee Flow Systems |
| A50Universal | Apogee Flow Systems |
| Auto40 | Apogee Flow Systems |
| FlowSight | Amnis |
| Image Stream^{X} Mark II | Amnis |
| JSAN | Bay Bioscience |
| CytoSense | CytoBuoy |
| CytoSub | CytoBuoy |
| CytoSense | CytoBuoy |
| CytoBuoy | CytoBuoy |
| Cytonome Viva ™ G1 | CYTONOME |
| GigaSort ™ | CYTONOME |
| Hydris | CYTONOME |
| Agilent 2100 Bioanalyzer | Agilent Technologies |
| NovoCyte | ACEA Biosciences |
| CyFlow ® Space | Partec technology |
| CyFlow ®Cube 8 | Partec technology |
| CyFlow ® Cube 6 | Partec technology |
| CyFlow ® Ploidy Analyser | Partec technology |
| CyFlow ® Counter | Partec technology |
| CyFlow ® miniPOC | Partec technology |
| CyFlow ® SL | Partec technology |
| CyFlow ® Sorter | Partec technology |
| CyFlow ® CCA | Partec technology |
| CyFlow ® Oenolyser | Partec technology |
| NucleoCounter ® NC-3000 ™ | Chemometec |
| NucleoCounter ® NC-250 ™ | Chemometec |
| NucleoCounter ® NC-200 ™-High | Chemometec |
| Precision Cell Counter | |
| HPC-100 Portable Flow Cytometer | Cronus Technologies Ltd |
| Cytell Cell Imaging System | GE Healthcare |
| MAGPIX | Luminex |
| Luminex ® 100/200 ™ System | Luminex |
| FLEXMAP 3D ® | Luminex |
| ImageXpress ® Velos Laser | molecular devices |
| Scanning Cytometer | |
| ClonePix ™ 2 | molecular devices |
| SpectraMax ® i3 | molecular devices |
| AQ1 Discrete Analyzer | SEAL Analytical Ltd. |
| AQ2 Discrete Analyzer | SEAL Analytical Ltd. |
| AQ400 Discrete Analyzer | SEAL Analytical Ltd. |
| AQUA 900 | SEAL Analytical Ltd. |
| AA3 HR AutoAnalyzer | SEAL Analytical Ltd. |
| AA1 AutoAnalyzer | SEAL Analytical Ltd. |
| QuAAtro39 | SEAL Analytical Ltd. |
| Infralyzer 2000 | SEAL Analytical Ltd. |
| Technicon AutoAnalyzer II (AAII) | SEAL Analytical Ltd. |
| Technicon/Bran + Luebbe | SEAL Analytical Ltd. |
| TrAAcs 800-2000 | |
| Bran + Luebbe FIA Analyzer | SEAL Analytical Ltd. |
| BioSorter ® Large Particle | Union Biometrica, Inc. |
| Flow Cytometer | |
| COPAS ™ Large Particle | Union Biometrica, Inc. |
| Flow Cytometers | |
| Cellometer Mini Cell Counter | Nexcelom |
| Cellometer Auto T4 Cell | Nexcelom |
| Viability Counter | |
| Cellometer Auto X4 Cell | Nexcelom |
| Viability Counter | |
| Cellometer Auto | |
| Nexcelom | |
| Viability Counter | |
| Cellometer Auto | |
| Nexcelom | |
| Viability Counter | |
| Cellometer Vision CBA | Nexcelom |
| Celigo S | Nexcelom |
| NovoCyte ™ 1000 | ACEA |
| NovoCyte ™ 2000 | ACEA |
| NovoCyte ™ 2060 | ACEA |
| NovoCyte ™ 3000 | ACEA |
| HPC-100 | Handyem |
| S1000 EXi | Stratedigm |
| SE520Xi | Stratedigm |
| Sysmex ® DI-60 | Sysmex |
| CellaVision ® DM96 | Sysmex |
| CellaVision ® DM1200 | Sysmex |
| Cytation | BioTek |
| EasyCell Assistant | Medica |
| IN Cell Analyzer | GE Healthcare |

TABLE 3
Exemplary instruments (continued).
Flourish List

| | |
|---|---|
| Big Blue | BD ® Biosciences |
| Kermit | Miltenyi |
| ac6 | BD ® Biosciences |
| srDAs | BD ® Biosciences |
| a | BD ® Biosciences |
| FACSCanto II Immunology | BD ® Biosciences |
| Test Cyt | Millipore |
| milt | Miltenyi |
| ac | BD ® Biosciences |
| ietest | BD ® Biosciences |
| Curiel's Aria | BD ® Biosciences |
| AttuneÄ ®Acoustic Focusing | Life Technologies |
| Cytometer Blue/Violet | |
| Medawar LSRII | BD ® Biosciences |
| Medawar Calibur | BD ® Biosciences |
| FACSAria INER | BD ® Biosciences |
| Attune R/A | Life Technologies |
| Fortessa | BD ® Biosciences |
| Aria | BD ® Biosciences |
| SORTER | BD ® Biosciences |
| Cyan | Beckman Coulter ® |
| LSR II | BD ® Biosciences |
| ARIA | BD ® Biosciences |
| Canto II | BD ® Biosciences |
| F09-LSR Fortessa I | BD ® Biosciences |
| “The Hoff” | BD ® Biosciences |
| 6th Floor Hess Fortessa A | BD ® Biosciences |
| Cerebro BDFACSAriaII | BD ® Biosciences |
| Mystique BDFACSAriaIII | BD ® Biosciences |
| Godzilla BDFACSAriaII | BD ® Biosciences |
| Wolverine BDFACSAriaII | BD ® Biosciences |
| Megatron BDFACSAriaII | BD ® Biosciences |
| Megatron BDFACSAriaII | BD ® Biosciences |
| Fortessa B | BD ® Biosciences |
| 6 colour Canto II | BD ® Biosciences |
| 10 colour LSR II | BD ® Biosciences |
| 4 laser 13 colour Influx sorter | BD ® Biosciences |
| 14 colour X20 | BD ® Biosciences |
| SORP | BD ® Biosciences |
| FACSAria INER | BD ® Biosciences |
| LSR561 | BD ® Biosciences |
| Fortessa FCF UZH | BD ® Biosciences |
| LSR 2 B | BD ® Biosciences |
| LSRII-C | BD ® Biosciences |
| Cal 3 | BD ® Biosciences |
| Aria II A | BD ® Biosciences |
| LSR 16 | BD ® Biosciences |
| LSB Fortessa | BD ® Biosciences |
| IMMUN LSRII | BD ® Biosciences |
| IRC | BD ® Biosciences |
| UV LSR | BD ® Biosciences |
| 5 Laser Aria | BD ® Biosciences |
| Curiel's LSR II | BD ® Biosciences |
| LSR Fortessa | BD ® Biosciences |
| Mauzeroll Aria | BD ® Biosciences |
| Frenette | BD ® Biosciences |
| Fallon | Beckman Coulter ® |
| Galios | Beckman Coulter ® |
| LSRIIFortessa | BD ® Biosciences |
| FACSCanto II CLSB | BD ® Biosciences |
| LSR II SC | BD ® Biosciences |
| UNCA Fortessa | BD ® Biosciences |
| VERSE | BD ® Biosciences |
| ARIAII | BD ® Biosciences |
| ARIAIII | BD ® Biosciences |
| F09-BD LSRFortessa | BD ® Biosciences |
| HMRI FACSCanto II A | BD ® Biosciences |
| HMRI FACSCantoII B (HTS) | BD ® Biosciences |
| HMRI Aria III | BD ® Biosciences |
| L2 | BD ® Biosciences |
| UoN Canto | BD ® Biosciences |
| LSRII M902 | BD ® Biosciences |
| Fortessa 1 | BD ® Biosciences |
| F05-FACSAria | BD ® Biosciences |
| F02-FACSAria III | BD ® Biosciences |
| F10-BD FACSAria III | BD ® Biosciences |
| F03-Guava | Millipore |
| Aria Blue 11 Color | BD ® Biosciences |
| Aria Red | BD ® Biosciences |
| Aria Orange | BD ® Biosciences |
| Aria Cyan | BD ® Biosciences |
| Aria Emerald | BD ® Biosciences |
| Aria Silver BSL3 | BD ® Biosciences |
| LSR Fortessa | BD ® Biosciences |
| LSR II Bldg 4 | BD ® Biosciences |
| LSR Fortessa bldg 4 | BD ® Biosciences |
| CANTO II Bldg 50 | BD ® Biosciences |
| 4 Laser LSR II | BD ® Biosciences |
| 5 Laser LSR II | BD ® Biosciences |
| FACSArray BL-2 | BD ® Biosciences |
| FACSCalibur | BD ® Biosciences |
| DUAL for long term studies | BD ® Biosciences |
| MoFlo 1095 Production only | Beckman Coulter ® |
| BL-2 FACSAria III sorter | BD ® Biosciences |
| Astrios BL-2 sorter | Beckman Coulter ® |
| Tessy | BD ® Biosciences |
| LSR II-1 | BD ® Biosciences |
| Fortessa | BD ® Biosciences |
| 4 laser AriaIII | BD ® Biosciences |
| LSRFortessa | BD ® Biosciences |
| UoN FACSAria II cell sorter | BD ® Biosciences |
| Door | Beckman Coulter ® |
| Fortessa | BD ® Biosciences |
| WCI-FACSAria I | BD ® Biosciences |
| LSRII Karp8 | BD ® Biosciences |
| Karp 8 | BD ® Biosciences |
| Canto | BD ® Biosciences |
| Aria sorter | BD ® Biosciences |
| DI lab | BD ® Biosciences |
| DI FACSAria | BD ® Biosciences |
| Constance | BD ® Biosciences |
| DI FACSAria III | BD ® Biosciences |
| WCI_FACS Canto | BD ® Biosciences |
| MACSQuant 10 | Miltenyi |
| VAMC Memphis LSR | BD ® Biosciences |
| VAMC Memphis S3 | Bio-Rad |
| ARIA INER | BD ® Biosciences |
| Uhura | BD ® Biosciences |
| Kirk | BD ® Biosciences |
| Data | Millipore |
| Spock | BD ® Biosciences |
| McCoy | BD ® Biosciences |

In some embodiments, multiple levels of scattering can be achieved via variations in hydrogel particle modifications, which may include one or more of: bovine serum albumin (BSA) cooking, nanoparticle loading, porosity, polymer composition, or gel fraction (e.g., polymer concentration) tuning.

In some embodiments, hydrogel particles (e.g., beads) can be conjugated with different fluorophores/biomiacromolecules for clear identification of each population, which may be particularly useful when multiple populations within the same collection cannot be separated by scatter due to saturation, wrong cytometer setting(s), and/or insufficient detector sensitivity.

In some embodiments, hydrogel particles (e.g., beads) can be conjugated with different levels of fluorophores/biomacromolecules so that the fluorescence and scatter scaling of cytometers can be calibrated simultaneously. The various levels of fluorophores/biomiacromolecules can also be quantified to serve as a quantification standard.

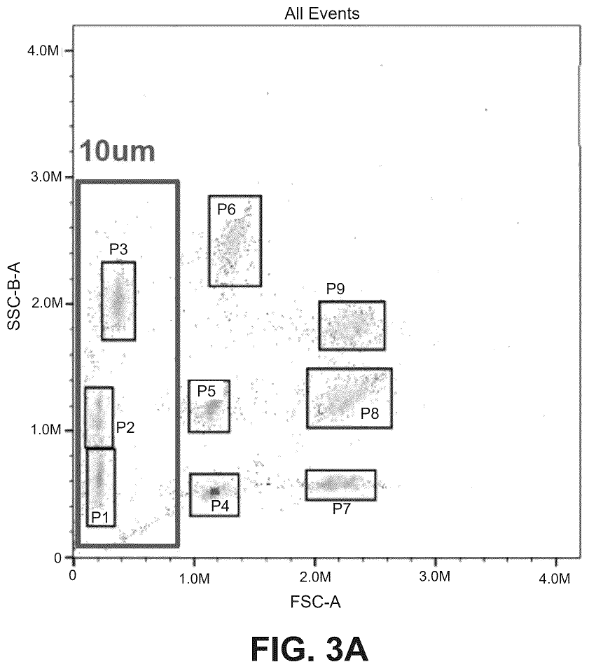

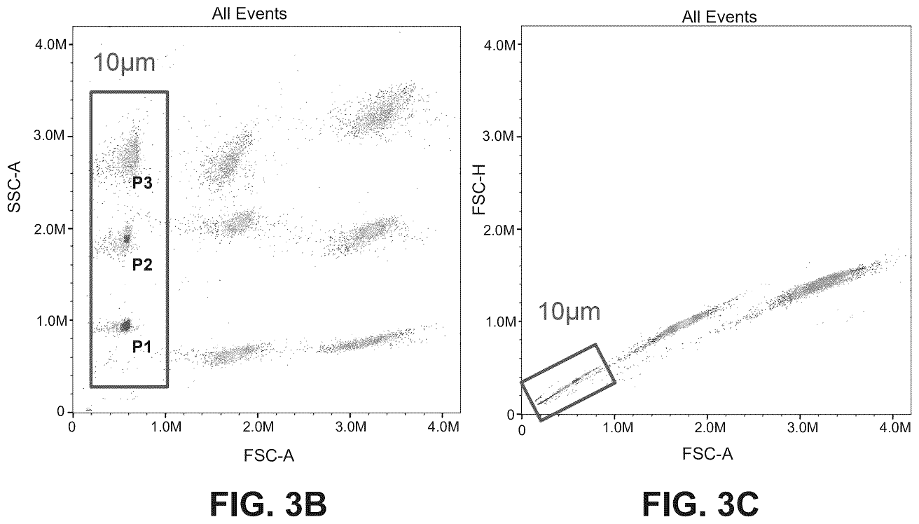

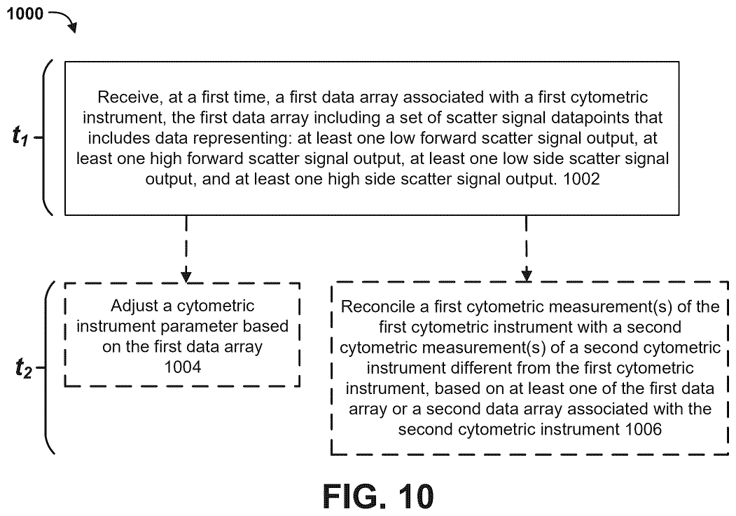

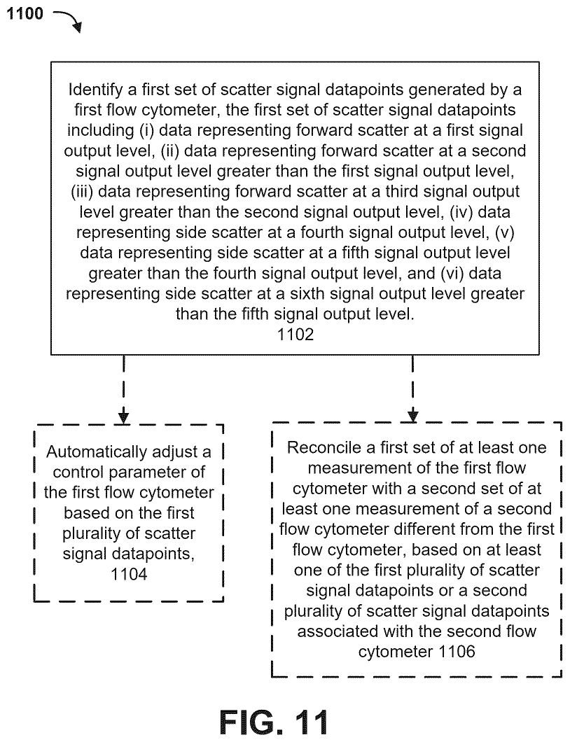

FIG. 2 is a diagram showing a system 200 for adjusting and/or cross-calibrating of flow cytometers based on ScatterGrid or ScatterBridge data (e.g., multi-population datasets generated using hydrogel particles), according to some embodiments. As shown in FIG. 2, the system 200 includes one or more ScatterGrid or ScatterBridge servers 220, in operable communication with one or more flow cytometers 210 via a network N (which may include one or more wireless and/or wired telecommunications networks). Optionally, the ScatterGrid or ScatterBridge server(s) 220 and/or the flow cytometer(s) 210 are operably coupled (e.g., via the network N) to one or more databases 250 or other storage media (e.g., including cloud-hosted storage media). Each of the ScatterGrid or ScatterBridge servers 220 includes a processor 224 operably coupled to a memory 222, a transceiver 226, and optionally a user interface 228 (e.g., including a graphical user interface (GUI) via which a user, such as an administrative user, may interact). The memory 222 stores processor-executable instructions 222A to perform one or more methods described herein (e.g., method 1000 of FIG. 10 or method 1100 of FIG. 11, discussed below). The instructions 222A can include one or more algorithms 222B, which may include machine learning algorithms. The memory 222 also stores one or more of: ScatterGrid or ScatterBridge data 222C (optionally including FSC data 222D and/or SSC data 222E), instrument settings 222F, instrument data 222G, adjustment data 222H, historical data 222I, or cross-calibration data 212J. The ScatterGrid or ScatterBridge data 222C can include data generated by one or more flow cytometers using one or more hydrogel particle formulations of the present disclosure. The ScatterGrid or ScatterBridge data 222C can be stored as/arranged in one or more matrices or other two-dimensional (2D) or three-dimensional (3D) formats, for example as shown and discussed below with reference to FIGS. 3 through 9B. The instrument settings 222F can include settings such as FSC gain, SSC gain, fluorescence gain, and laser power associated with one or multiple flow cytometers or other instrumentation. The instrument data 222G can include identifiers (e.g., serial numbers), model numbers, manufacturer names, model names, maintenance event data, authorized user identifiers, etc., associated with one or multiple flow cytometers or other instrumentation. The adjustment data 222H can include representations of adjustments made to the instrument settings 222F of one or multiple flow cytometers or other instrumentation, e.g., based on the ScatterGrid or ScatterBridge data 222C. The historical data 222I can include, for example, records associating one or more of: past adjustments made to one or multiple flow cytometers or other instrumentation, maintenance events associated with the one or multiple flow cytometers or other instrumentation, ScatterGrid or ScatterBridge data 222C, instrument settings 222F, instrument data 222G, adjustment data 222H, cytometry measurements, etc. The cross-calibration data 222J can include data derived from the ScatterGrid or ScatterBridge data 222C and that, for example, can be used to reconcile measurements made by a first flow cytometer with measurements made by a second flow cytometer, or can be used to adjust one or more settings/parameters of the first flow cytometer such that the first flow cytometer will produce measurements that are more consistent with the measurements made by the second flow cytometer, or that can be used to adjust one or more measurements made by the first flow cytometer such that the adjusted one or more measurements of the first flow cytometer are consistent with (or better correlate with) one or more measurements of the second flow cytometer.

Similar to the ScatterGrid or ScatterBridge servers 220, each of the flow cytometer(s) 210 can include a processor 214 operably coupled to a memory 212, a transceiver 216, and optionally a user interface 218 (e.g., including a graphical user interface (GUI) via which a user “U,” such as an operator, may interact). The memory 212 stores processor-executable instructions 212A to perform one or more methods described herein (e.g., method 1000 of FIG. 10 or method 1100 of FIG. 11, discussed below). The memory 212 also stores one or more of: ScatterGrid or ScatterBridge data 212C (optionally including FSC data 212D and/or SSC data 212E), instrument settings 212F, instrument data 212G, adjustment data 212H, or historical data 212I. The ScatterGrid or ScatterBridge data 212C can include data generated by the associated flow cytometer 210 using one or more hydrogel particle formulations of the present disclosure. Similar to ScatterGrid or ScatterBridge data 222C, the ScatterGrid or ScatterBridge data 212C can be stored as/arranged in one or more matrices or other two-dimensional (2D) or three-dimensional (3D) formats, for example as shown and discussed below with reference to FIGS. 3 through 9B. The instrument settings 212F can include settings such as FSC gain, SSC gain, and fluorescence gain, associated with one or multiple flow cytometers or other instrumentation. The instrument data 212G can include an identifier (e.g., a serial number), model number, manufacturer name, model name, maintenance event data, authorized user identifiers, etc., associated with the flow cytometer 210. The adjustment data 212H can include representations of adjustments made to the instrument settings 212F of the flow cytometer 210, e.g., based on the ScatterGrid or ScatterBridge data 212C. The historical data 212I can include, for example, records associating one or more of: past adjustments made to one or multiple flow cytometers or other instrumentation, maintenance events associated with the one or multiple flow cytometers or other instrumentation, ScatterGrid or ScatterBridge data 212C, instrument settings 212F, instrument data 212G, adjustment data 212H, cytometry measurements, etc.

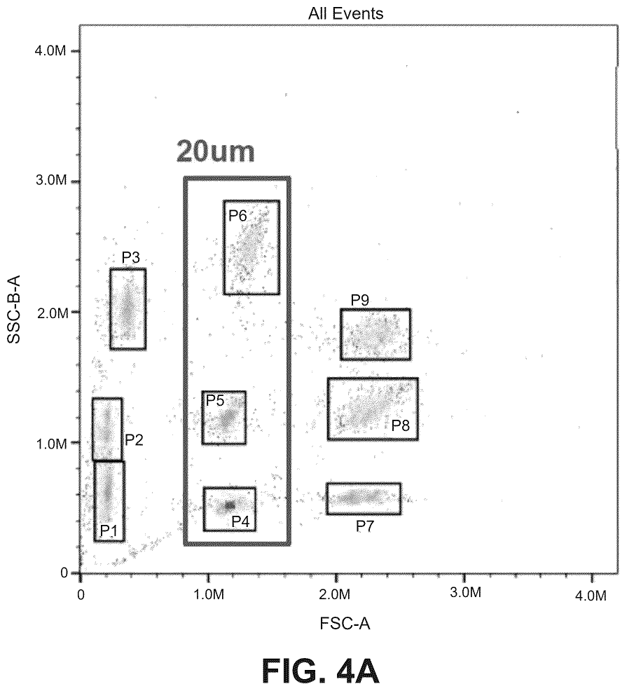

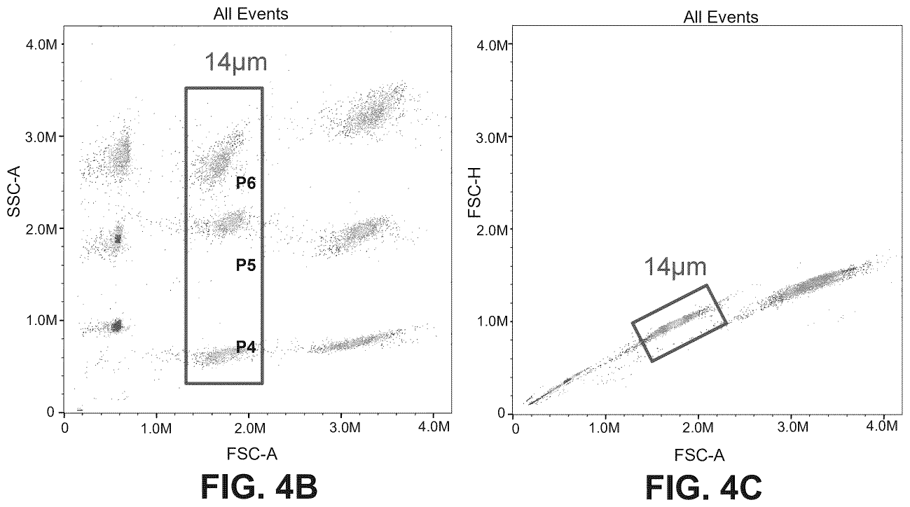

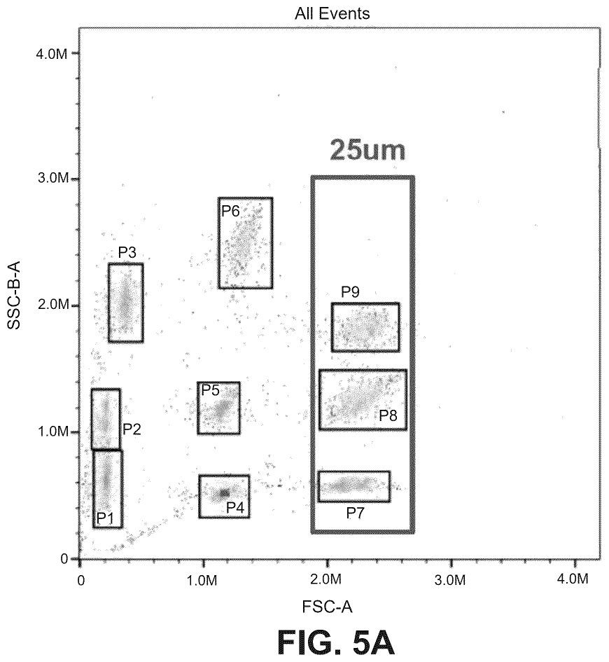

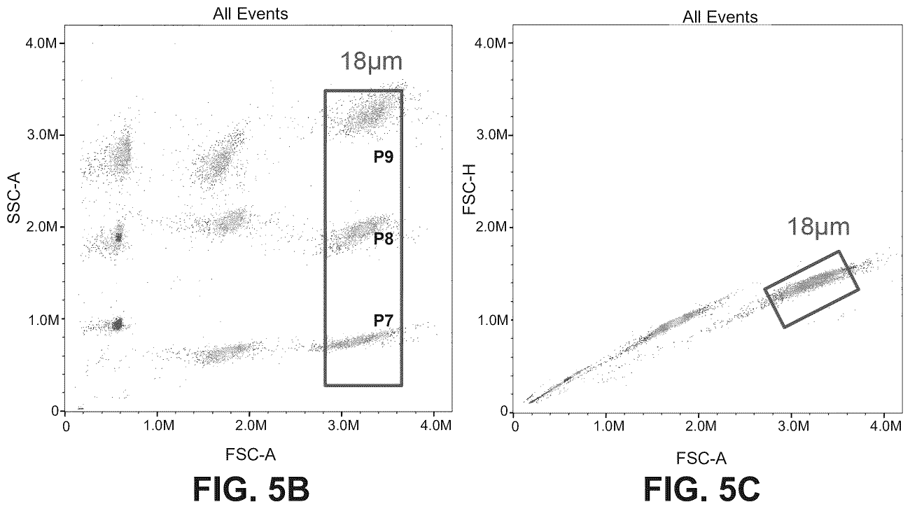

FIGS. 3A, 4A, and 5A depict an exemplary ScatterGrid-based scatter data, sequentially annotating subsets of data generated using hydrogel particles (e.g., beads) of varying average diameters (10 micrometers (μm), 20 μm, and 25 μm, respectively), according to some embodiments. For example, the 10 μm box shown in FIG. 3A includes population “P1” (corresponding to a low FSC signal output and a low SSC signal output), population “P2” (corresponding to a low FSC signal output and a medium SSC signal output), and population “P3” (corresponding to a low FSC signal output and a high SSC signal output). Similarly, the 20 μm box shown in FIG. 4A includes population “P4” (corresponding to a medium FSC signal output and a low SSC signal output), population “P5” (corresponding to a medium FSC signal output and a medium SSC signal output), and population “P6” (corresponding to a medium FSC signal output and a high SSC signal output). Similarly, the 25 μm box shown in FIG. 5A includes population “P7” (corresponding to a high FSC signal output and a low SSC signal output), population “P8” (corresponding to a high FSC signal output and a medium SSC signal output), and population “P9” (corresponding to a high FSC signal output and a high SSC signal output).

FIGS. 3B-3C, 4B-4C, and 5B-5C depict an exemplary ScatterBridge-based scatter data, sequentially annotating subsets of data generated using hydrogel particles (e.g., beads) of varying average diameters (10 micrometers (μm), 14 μm, and 18 μm, respectively), according to some embodiments. For example, the 10 μm box shown in FIG. 3B includes population “P1” (corresponding to a low FSC signal output and a low SSC signal output), population “P2” (corresponding to a low FSC signal output and a medium SSC signal output), and population “P3” (corresponding to a low FSC signal output and a high SSC signal output). Similarly, the 20 μm box shown in FIG. 4B includes population “P4” (corresponding to a medium FSC signal output and a low SSC signal output), population “P5” (corresponding to a medium FSC signal output and a medium SSC signal output), and population “P6” (corresponding to a medium FSC signal output and a high SSC signal output). Similarly, the 25 μm box shown in FIG. 5B includes population “P7” (corresponding to a high FSC signal output and a low SSC signal output), population “P8” (corresponding to a high FSC signal output and a medium SSC signal output), and population “P9” (corresponding to a high FSC signal output and a high SSC signal output). FIGS. 3C, 4C, and 5C each show respective, gated populations corresponding to a low FSC-A signal output and a low FSC-H signal output, a medium FSC-A signal output and a low FSC-H signal output, and a high FSC-A signal output and a low FSC-H signal output, respectively.

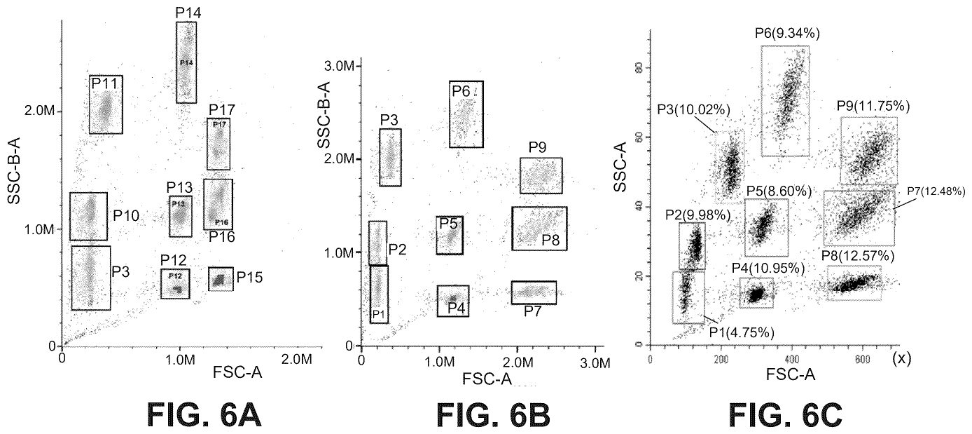

FIGS. 6A-6C show exemplary ScatterGrid-based scatter data generated by three different flow cytometers (a Cytek® NL-2000 flow cytometer, a Cytek® Aurora flow cytometer, and a Beckman Coulter® Cytoflex 5 flow cytometer, respectively), each ScatterGrid including data for/representing nine populations of hydrogels, denoted by rectangular gates, in accordance with some embodiments. The plots of FIGS. 6A-6C show that the same populations of hydrogels will produce different scatter signal responses (and, thus, different scatterplots) on different types of flow cytometers. The scales of the signals are distinct, and the positions of the populations are distinct relative to one another. Although the population numbering shown in FIGS. 6A-6C is arbitrary, in other implementations data points representing the same populations of hydrogel particles across the plots are annotated with the same numbering.

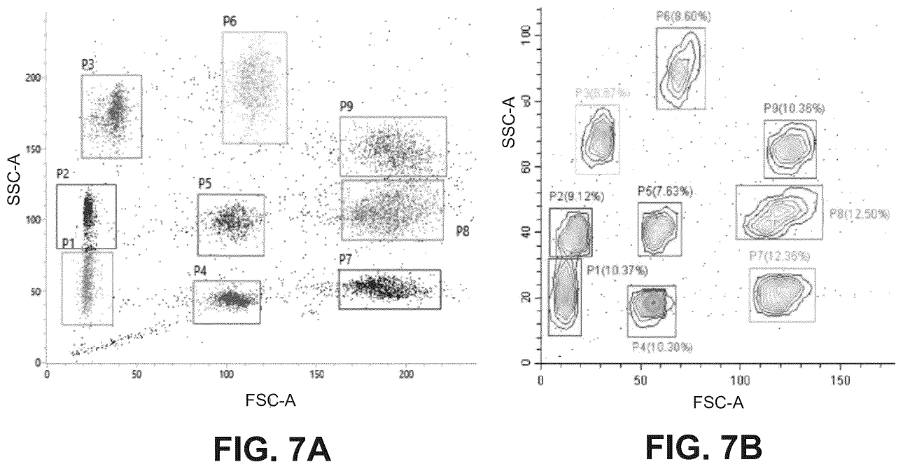

FIG. 7A and FIG. 7B show exemplary ScatterGrid-based scatter data generated by two different flow cytometers (a BD® Biosciences FACSLyric™ flow cytometer and a Beckman Coulter™ Cytoflex LX flow cytometer, respectively), each ScatterGrid including data for/representing nine populations of hydrogels, in accordance with some embodiments. Again, the same populations of hydrogels produce different scatter signal responses (and, thus, different scatterplots) across different flow cytometers.

FIGS. 8A-8C show ScatterGrid-based scatter data generated by a single Cytek® NL-2000 flow cytometer at three different times: prior to preventive maintenance being performed on the Cytek® NL-2000 flow cytometer (FIG. 8A), after preventive maintenance (FIG. 8B), and after both the preventive maintenance and an adjustment to the FSC gain of the Cytek® NL-2000 flow cytometer (FIG. 8C), in accordance with an embodiment. More specifically, as can be observed when comparing the scatterplots of FIG. 8A and FIG. 8B, an acquisition run using a hydrogel particle composition prior to preventive maintenance and using a FSC gain setting of 29 produced a ScatterGrid with a markedly different appearance/distribution than a ScatterGrid produced in an acquisition run using the same hydrogel particle after the preventive maintenance and using the same FSC gain setting of 29. Moreover, in response to the ScatterGrid of FIG. 8A and FIG. 8B, the FSC gain setting of the flow cytometer was adjusted from 29 to 50, resulting in the scatterplot of FIG. 8C, which is substantially realigned with the scatterplot of FIG. 8A.

FIG. 9A is a plot showing first data generated by a first flow cytometer, the first data including ScatterGrid-based scatter data, data generated using TruCyte TBNK biomarker mimics (synthetic cells), and data generated using biological cells, in accordance with an embodiment. FIG. 9B is a plot showing second data generated by a second flow cytometer (a Cytek® Aurora flow cytometer), the second data including ScatterGrid-based scatter data, and the plot also showing guide locations for synthetic cell mimic controls matching the scatter signal of the biological sample controls of the first flow cytometer, relative to the ScatterGrid-based scatter data and in accordance with an embodiment. Guide locations can be identified based on relevant location compared to ScatterGrid-based scatter data subpopulations. Based on the plot of FIG. 9A, a determination was made as to the relative relationship between the biological cells and ScatterGrid-based scatter data populations in the first flow cytometer. That information was used to create controls, for verification via the second flow cytometer. Based on observing that the controls have the same relative relationship with ScatterGrid-based scatter data as do the cells, it can be concluded that the controls are identical to the biological cells of interest when using the first flow cytometer. ScatterGrid-based scatter data can be used in this manner for both positive and negative controls (“positive” and “negative” referring to biomarker presence or no biomarker presence, respectively). The numerical values on the x and y axes of FIGS. 9A-9B are arbitrary intensity signal values across different flow cytometry instruments. ScatterGrid-based scatter data can be used as a “map” to determine/coordinate relative scatter positions when tracking a scatter signal of interest.

FIG. 10 is a flow diagram showing a method for adjusting a cytometric instrument and/or reconciling cytometric measurements, based on ScatterGrid or ScatterBridge data, according to some embodiments. The method 1000 of FIG. 10 can be implemented, for example, using a system such as system 200 of FIG. 2. As shown in FIG. 10, the method 1000 includes receiving, at 1002 and at a first time (t₁), a first data array associated with a first cytometric instrument. The first data array includes a set of scatter signal datapoints that includes data representing: at least one low forward scatter signal output, at least one high forward scatter signal output, at least one low side scatter signal output, and at least one high side scatter signal output. At a second time (t₂) subsequent to the first time, a cytometric instrument parameter is optionally adjusted, at 1004, based on the first data array, and/or a first cytometric measurement of the first cytometric instrument is optionally reconciled, at 1006, with a second cytometric measurement of a second cytometric instrument different from the first cytometric instrument, based on at least one of the first data array or a second data array associated with the second cytometric instrument.

In one embodiment, at 1004, when the first data array is cytometric data obtained from hydrogel particles, which constitutes a ScatterGrid or ScatterBridge, the resulting FSC and SSC can be compared with known, standard FSC and SSC values for the same hydrogel particles and, when the comparison satisfies a threshold (e.g., the comparison indicates the cytometer needs to be calibrated), the adjustments to the cytometric instrument may be made. In embodiments, the resulting FSC-A and FSC-H can be compared with known, standard FSC-A and FSC-H values for the same hydrogel particles and, when the comparison satisfies a threshold (e.g., the comparison indicates the cytometer needs to be calibrated), the adjustments to the cytometric instrument may be made.

In one embodiment, at 1006, when the first data array is cytometric data obtained by a first cytometric instrument from hydrogel particles, which constitutes a ScatterGrid or ScatterBridge, the resulting FSC and SSC (or FSC-A and FSC-H) can be compared with known, standard FSC and SSC (or FSC-A and FSC-H) values for the same hydrogel particles (i.e., second data array associated with a second cytometric instrument) and, when the comparison satisfies a threshold (e.g., the comparison indicates the first cytometer has drifted), the reconciliations to the first data array may be made. To this end, at 1006, an algorithm may attempt to generate a matrix function to map the standard FSC and SSC values onto the first data array. When a QC measurement of the generated function (e.g., a confidence score, etc.) is higher than a predetermined value, the algorithm then proceeds to correct and/or standardize the data in the first data array and may use this updated function to correct future data. As an example, the updated function may be applied to an actual sample of interest and corrected and/or standardized data can be generated without hardware or software calibration of the flow cytometry instrument.

In some implementations, method 1000, including 1004 and 1006, is performed iteratively so that the calibration of the cytometric instrument and/or accuracy of the processed scatter data is maintained and/or the longitudinal performance of the cytometric instrument is maintained. For instance, at each time point from a plurality of time points of a longitudinal study (the time points of the plurality of time points optionally having predefined time intervals therebetween and/or according to a predefined schedule), ScatterGrid or ScatterBridge data can be acquired, and actual sample data can be reconciled with the ScatterGrid or ScatterBridge data to correct and/or standardize the sample data. These corrections prevent drift or other non-ideal characteristics from impacting the readouts from the actual sample data measured over multiple time durations.

In another embodiment, at 1006, the first cytometric instrument and the second cytometric instrument are both used to obtain information about unknown cell populations. Data for each cytometric instrument based on the hydrogel particles associated with the ScatterGrid or ScatterBridge are used to ensure consistent measurements across instruments. A first data array, corresponding to cytometric data obtained on the first cytometric instrument for hydrogel particles associated with the ScatterGrid or ScatterBridge, and a second data array, corresponding to cytometric data obtained from the second cytometric instrument, can each be compared with a corresponding ScatterGrid or ScatterBridge of known FSC and SSC values. Corrections and/or standardizations of data for each data array can be made until both data arrays are brought into harmony. For instance, a function can be generated for each of the first data array and the second data array, based on the ScatterGrid or ScatterBridge, that permits mapping of that function onto actual samples of interest to ensure that, despite each instrument having different settings and possibly different raw outputs, processed data from each of the first cytometric instrument and the second cytometric instrument will be consistent and comparable.

In some implementations, the method 1000 also includes computationally adjusting at least one of a side scatter signal or a forward scatter signal based on the first data array and a second data array, the first data array associated with a first time, and the second data array associated with a second time occurring after the first time and after a modification to a setting of the first cytometric instrument. Optionally, the plurality of scatter signal datapoints also includes data representing at least one medium forward scatter signal output, and data representing at least one medium side scatter signal output.

In some implementations, the first data array includes a two-dimensional arrangement (e.g., a square arrangement or a rectangular arrangement) of the scatter signal datapoints from the plurality of scatter signal datapoints.

In some implementations, the first data array is generated via a single acquisition run of the first cytometric instrument, using a hydrogel particle formulation. A difference between the at least one low forward scatter signal output and the at least one high forward scatter signal output can be due to at least one of: a monomer/crosslinker ratio of the hydrogel particle formulation, a gel fraction of the hydrogel particle formulation, or a particle size associated with the hydrogel particle formulation (e.g., a size of one or more hydrogel particles from the hydrogel particle formulation). Alternatively or in addition, a difference between the at least one low side scatter signal output and the at least one high side scatter signal output is due to at least one of a nanoparticle loading of the hydrogel particle formulation, a hydrogel porosity of the hydrogel particle formulation, or a protein conjugation (e.g., a heat crosslinking of protein such as bovine serum albumin (BSA) cooking) associated with the hydrogel particle formulation.

In some implementations, the first data array is unique to the first cytometric instrument.

In some implementations, the first data array is unique to the first cytometric instrument and the second data array is unique to the second cytometric instrument.

In some implementations, the plurality of scatter signal datapoints further includes data representing at least one additional level of forward scatter signal output (e.g., a medium forward scatter signal output).

In some implementations, the plurality of scatter signal datapoints further includes data representing at least one additional level of side scatter signal output (e.g., a medium side scatter signal output.

In some implementations, the plurality of scatter signal datapoints also includes data representing at least one additional level of forward scatter signal output and data representing at least one additional level of side scatter signal output (e.g., a medium forward scatter signal output and a medium side scatter signal output).

FIG. 11 is a flow diagram showing a method for automatically adjusting a control parameter of a flow cytometer and/or reconciling flow cytometer measurements, based on ScatterGrid or ScatterBridge data, according to some embodiments. The method 1100 of FIG. 11 can be implemented, for example, using a system such as system 200 of FIG. 2. As shown in FIG. 11, the method 1100 includes identifying, at 1102, a first plurality of scatter signal datapoints generated by a first flow cytometer. The first plurality of scatter signal datapoints includes (i) data representing forward scatter at a first signal output level, (ii) data representing forward scatter at a second signal output level greater than the first signal output level, (iii) data representing forward scatter at a third signal output level greater than the second signal output level, (iv) data representing side scatter at a fourth signal output level, (v) data representing side scatter at a fifth signal output level greater than the fourth signal output level, and (vi) data representing side scatter at a sixth signal output level greater than the fifth signal output level. The method 1100 also optionally includes at least one of: automatically adjusting, at 1104, a control parameter of the first flow cytometer based on the first plurality of scatter signal datapoints, or reconciling, at 1106, a first set of at least one measurement of the first flow cytometer with a second set of at least one measurement of a second flow cytometer different from the first flow cytometer, based on at least one of the first plurality of scatter signal datapoints or a second plurality of scatter signal datapoints associated with the second flow cytometer.

As shown above with reference to methods 1000 and 1100, the ScatterGrid or ScatterBridge of the present disclosure can be used as a custom reference to calibrate a cytometric instrument and/or can be used for inter-instrument (e.g., as a reference to adjust instrument settings across instruments to ensure standardized results) and/or intra-instrument calibration. Further, the ScatterGrid or ScatterBridge of the present disclosure can be used for data analysis to evaluate cytometric data obtained over the time course of a longitudinal study or for metadata analysis and harmonization of cytometric results across studies. For instance, the ScatterGrid or ScatterBridge can be used in single-cell analyses based on optical properties, such as hematology, flow cytometry, microfluidic cytometry, and the like. Moreover, the ScatterGrid or ScatterBridge can be used to monitor the health and degradation of a cell line over time. Live or dead cells can be detected. In some embodiments, the methods can be applied to various angles of scattering (e.g., back scattering, low angle scattering), size, and granularity (used in image-based cytometry methods), as well as in image cytometry, ghost cytometry, and cell sorting (e.g., FACS). Additionally, individual populations of hydrogel particles can be conjugated to various levels of markers, such as dyes, antigens, or nucleic acids, which further expand the dimensionality of the ScatterGrid or ScatterBridge to include other properties (such as fluorescence intensity). Ibis enables use in broader applications such as mass cytometry (CyTOF), laser scanning cytometry, and single-cell sequencing.

In some embodiments, the ScatterGrid or ScatterBridge can be used to identify unknown cells within a population. For instance, a relative location of the ScatterGrid or ScatterBridge to the unknown cell could be compared against known cells previously evaluated in the context of the ScatterGrid or ScatterBridge.

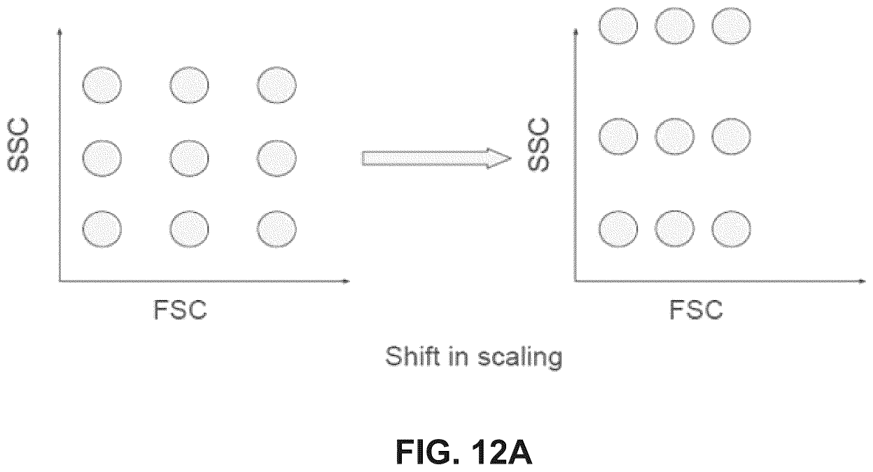

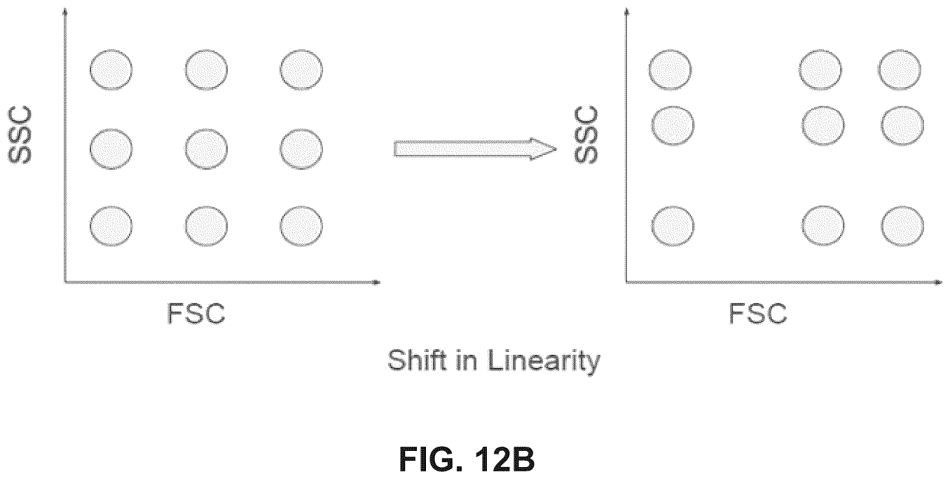

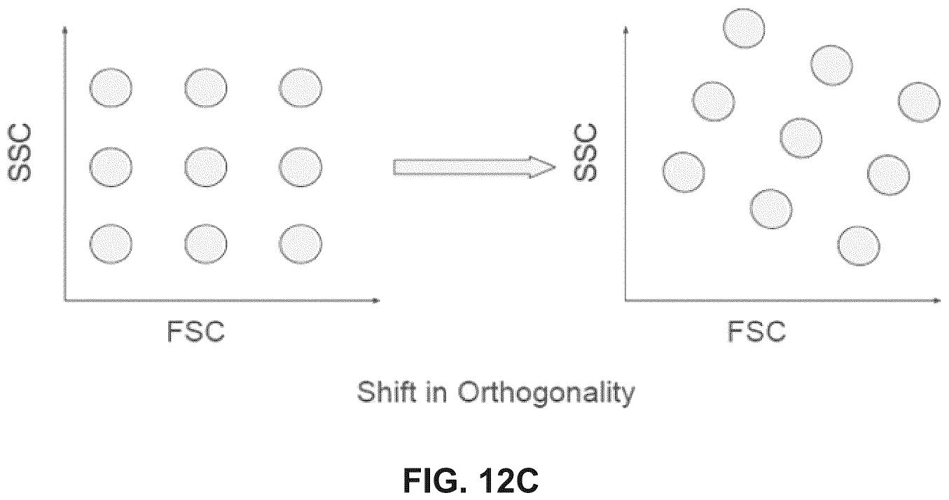

In some implementations, at 1004 and based on a comparison of a subsequent data array with the first data array (or nominal values) received at 1002, it is determined that a shift in scaling has occurred to the data, the adjustment to the cytometric instrument may be a voltage and/or gain adjustment, as shown in FIG. 12A. As shown in FIG. 12A, a shift in scaling causes dispersal in populations of scatter signal datapoints relative to the nominal values.

In some implementations, at 1004 and based on a comparison of a subsequent data array with the first data array (or nominal values) received at 1002, it is determined that a shift in linearity has occurred to the data, the adjustment to the cytometric instrument may be a laser alignment, a voltage and/or gain adjustment, and/or detector maintenance. As shown in FIG. 12B, a shift in linearity causes uniform distribution of populations of scatter signal datapoints relative to the nominal values.

In some implementations, at 1004 and based on a comparison of a subsequent data array with the first data array (or nominal values) received at 1002, it is determined that a shift in orthogonality has occurred to the data, the adjustment to the cytometric instrument may be a laser alignment and/or optics alignment. As shown in FIG. 12C, a shift in orthogonality causes a rotation of the spatial distribution of populations of scatter signal datapoints relative to the nominal values.

In some implementations, the method 1100 also includes causing display, via a user interface, the first plurality of scatter signal datapoints such that (i) through (vi) are depicted as clustered data populations spaced apart from one another.

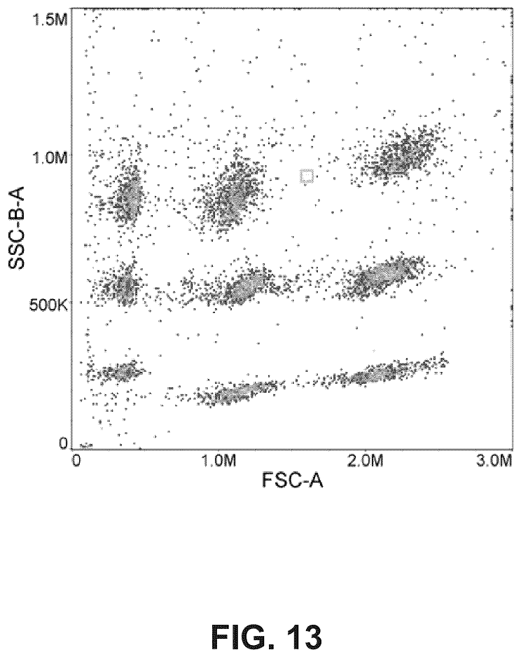

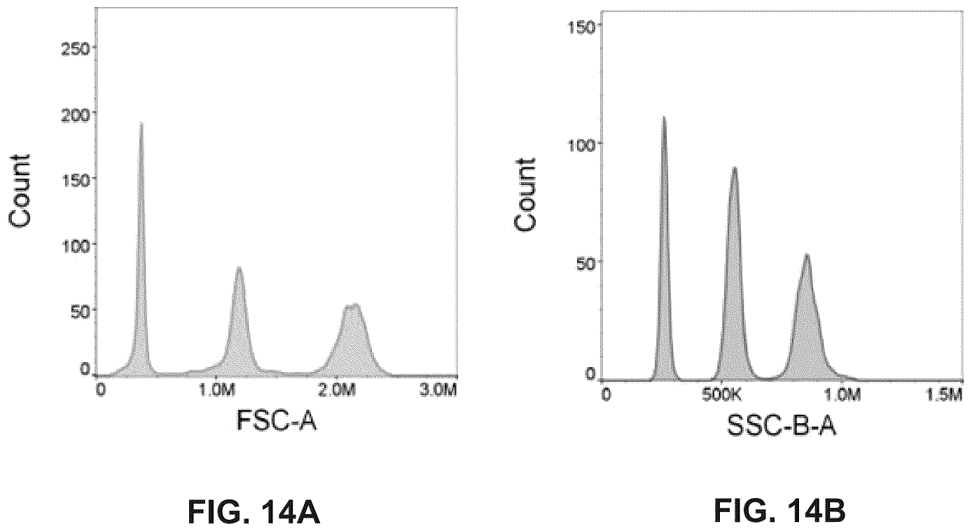

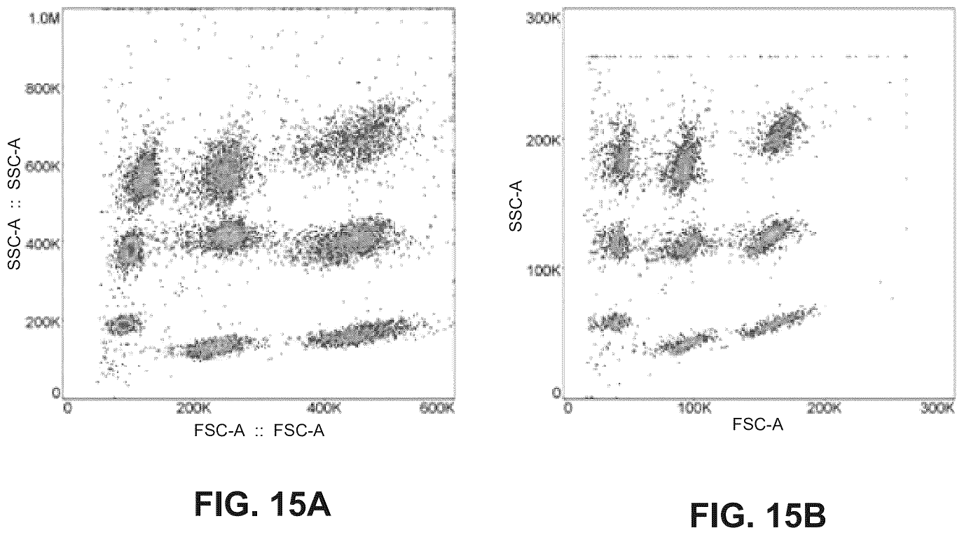

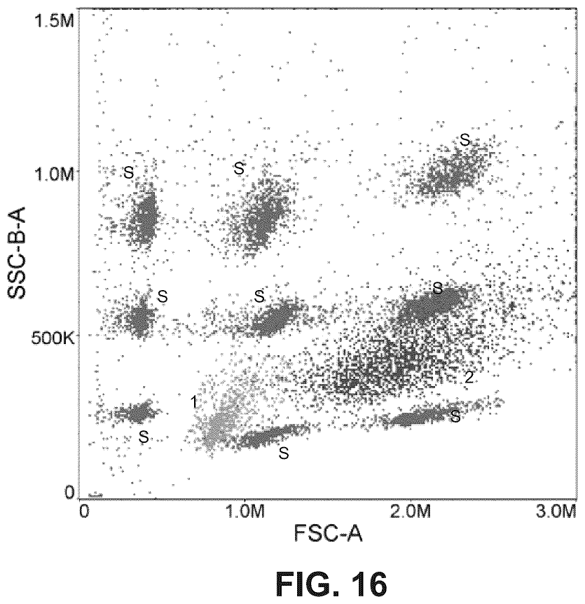

For example, in embodiments, a plurality of scatter signal datapoints may include nine unique, clustered data populations, similar to that shown in FIG. 13.

In some implementations, the method 1100 also includes causing the processor to cause display, via a user interface, the first plurality of scatter signal datapoints such that (i) through (vi) are arranged in a two-dimensional array.

In some implementations, the automatic adjustment of the control parameter of the first flow cytometer is based on the first plurality of scatter signal datapoints, and the automatic adjustment compensates for at least one of an instrument degradation of the first flow cytometer, a signal drift of the first flow cytometer, or noise.

In some implementations, the automatic adjustment of the control parameter of the first flow cytometer is based on the first plurality of scatter signal datapoints, and the automatic adjustment improves a response linearity across multiple subsequent measurements of the first flow cytometer. The automatic adjustment can, for example, include a computational adjustment of data for additional samples, based on the data from the first plurality of scatter signal datapoints (which may, for example, be associated with one or more historical samples) such that forward scatter and/or side scatter can be compared between or among multiple instruments (e.g., the first flow cytometer and at least the second flow cytometer) and/or between or among instrument settings for the multiple instruments.

In some implementations, the method 1100 also includes modifying sample data based on the first plurality of scatter signal datapoints. The sample data can include sample data generated by the first flow cytometer and sample data generated by the second flow cytometer.

In some implementations, the plurality of scatter signal datapoints also includes (vii) data representing forward scatter at a seventh signal output level greater than the third signal output level, and (viii) data representing side scatter at an eighth signal output level greater than the sixth signal output level.

In some implementations, the first plurality of scatter signal datapoints is uniquely associated with the first flow cytometer.

In some implementations, the first plurality of scatter signal datapoints is generated via a single acquisition run of the first flow cytometer, using a hydrogel particle formulation. A difference between any two of the first signal output level, the second signal output level, or the third signal output level can be due to at least one of a monomer/crosslinker ratio of the hydrogel particle formulation, a gel fraction of the hydrogel particle formulation, or a particle size associated with the hydrogel particle formulation (e.g., a size of one or more hydrogel particles from the hydrogel particle formulation). Alternatively, or in addition, a difference between any two of the fourth signal output level, the fifth signal output level, or the sixth signal output level can be due to at least one of a nanoparticle loading of the hydrogel particle formulation, a hydrogel porosity of the hydrogel particle formulation, or a protein conjugation associated with the hydrogel particle formulation.

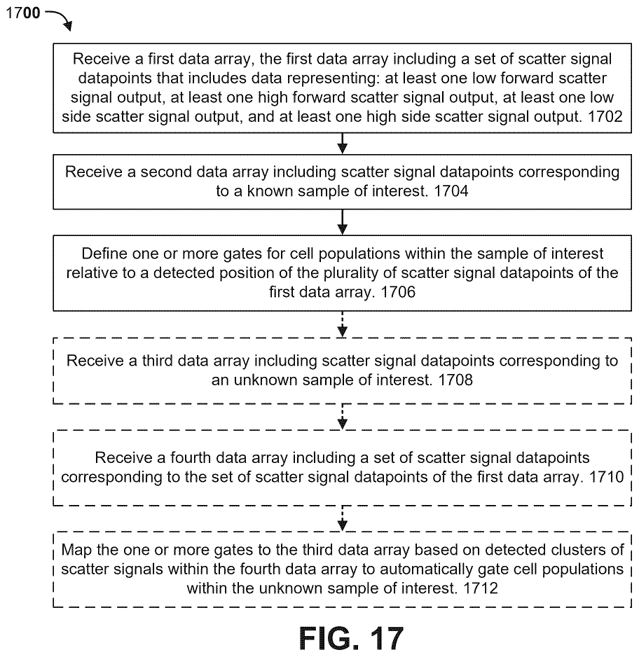

The ScatterGrid or ScatterBridge disclosed herein can be deployed for automated gating. Manual gating can be time consuming and adds variability to cytometric data, limiting ability to scale up data analysis. Existing automatic gating strategies rely on machine learning approaches to identify populations but require extensive training data which can be challenging for rare populations or with limited samples. Accordingly, FIG. 17 is a flow diagram showing a method for automated gating.

FIG. 17 is a flow diagram showing a method for generating and applying automatic gating. The method 1700 of FIG. 17 can be implemented, for example, using a system such as system 200 of FIG. 2. As shown in FIG. 17, the method 1700 includes receiving, at 1702, a first data array obtained by a cytometric instrument. The first data array, or ScatterGrid/ScatterBridge, may comprise a set of scatter signal datapoints that includes data representing: at least one low forward scatter signal output, at least one high forward scatter signal output, at least one low side scatter signal output, and at least one high side scatter signal output. At 1704, a second data array comprising scatter signal datapoints corresponding to a known sample of interest can be received from the cytometric instrument. In embodiments, the first data array and the second data array are obtained under the same laser power and gain settings. The known sample of interest may comprise one or more known cell populations with expected FSC and SSC values. At 1706, one or more gates can be defined for cell populations within the sample of interest. The one or more gates can be defined relative to a detected position of the plurality of scatter signal datapoints of the first data array. In embodiments, the position of clusters of the plurality of scatter signal datapoints of the first data array may be detected, manually or automatically using supervised learning techniques (e.g., density-based spatial clustering (DBScan) or K-means clustering with a defined number of clusters). Each gate can be defined for a population of interest relative to a median of each detected cluster of the plurality of scatter signal datapoints of the first data array.

With gates defined, 1708 can optionally be performed. When the third data array including scatter signal datapoints corresponding to an unknown sample of interest is received nearly simultaneously with, or shortly after, defining the one or more gates at 1706, method 1700 can include mapping the one or more defined gates onto the third data array to automatically gate cell populations within the unknown sample of interest. When the third data array including scatter signal datapoints corresponding to the unknown sample of interest is not received immediately after 1706, then 1710 and 1712 may optionally be performed. For instance, after obtaining the third data array from the cytometric instrument, a fourth data array can be obtained from the cytometric instrument. The fourth data array may comprise a set of scatter signal datapoints corresponding to the first data array and including data representing: at least one low forward scatter signal output, at least one high forward scatter signal output, at least one low side scatter signal output, and at least one high side scatter signal output. The fourth data array can be considered an updated version of the first data array to account for any differences between the cytometric instrument at the time the first data array was acquired and at the time the fourth data array was acquired. At 1712, the one or more gates, which are defined relative to the detected positions of the clusters of the first data array, can be mapped onto the third data array to automatically gate cell populations within the unknown sample of interest. In this way, any time-dependent shifts in instrument performance, differences between instruments or changes in instrument settings will be accounted for. This method also mitigates any operator-to-operator variability seen in manual gating.

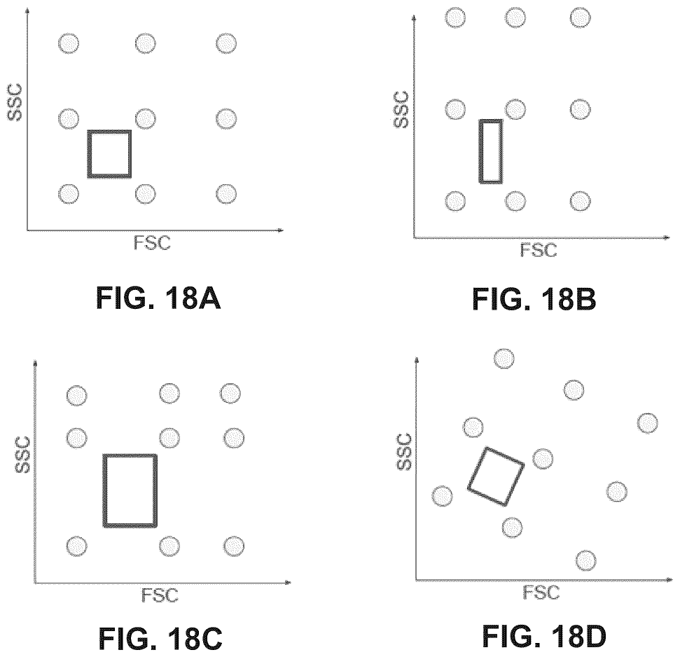

FIGS. 18A-18D provide graphical representations of how defining the one or more gates relative to the first data array, or ScatterGrid/ScatterBridge, permits wide use of the automatic gating feature without concern for re-calibration or shifting instrument characteristics and parameters.

All publications, patents, patent applications and other documents cited in this application are hereby incorporated by reference in their entireties for all purposes to the same extent as if each individual publication, patent, patent application or other document were individually indicated to be incorporated by reference for all purposes.

While various specific embodiments have been illustrated and described, it will be appreciated that various changes can be made without departing from the spirit and scope of the invention.

While various embodiments of the system, methods and devices have been described above, it should be understood that they have been presented by way of example only, and not limitation. Where methods and steps described above indicate certain events occurring in a certain order, those of ordinary skill in the art having the benefit of this disclosure would recognize that the ordering of certain steps may be modified, and such modifications are in accordance with the variations of the invention. Additionally, certain of the steps may be performed concurrently in a parallel process when possible, as well as performed sequentially as described above. The embodiments have been particularly shown and described, but it will be understood that various changes in form and details may be made. While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

As used herein, the following terms and expressions are intended to have the following meanings:

The indefinite articles “a” and “an” and the definite article “the” are intended to include both the singular and the plural, unless the context in which they are used clearly indicates otherwise.

“At least one” and “one or more” are used interchangeably to mean that the article may include one or more than one of the listed elements.

Unless otherwise indicated, it is to be understood that all numbers expressing quantities, ratios, and numerical properties of ingredients, reaction conditions, and so forth, are contemplated to be able to be modified in all instances by the term “about”.

As used herein, the terms “about” and “approximately” generally mean plus or minus 10% of the value stated, for example about 250 μm would include 225 μm to 275 μm, about 1,000 μm would include 900 μm to 1,100 μm.

As used herein, the term “gating” refers to the selection of successive subpopulations of cells for analysis in flow cytometry.

In this disclosure, references to items in the singular should be understood to include items in the plural, and vice versa, unless explicitly stated otherwise or clear from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth. The use of any and all examples, or exemplary language (“e.g.,” “such as,” “including,” or the like) provided herein, is intended merely to better illuminate the embodiments and does not pose a limitation on the scope of the embodiments or the claims.

1. A non-transitory, processor-readable medium storing instructions that, when executed by a processor, cause the processor to:
receive, at a first time, a first data array associated with a first cytometric instrument, the first data array including a plurality of scatter signal datapoints that includes:
data representing at least one low forward scatter signal output,
data representing at least one high forward scatter signal output,
data representing at least one low side scatter signal output, and
data representing at least one high side scatter signal output; and
at a second time subsequent to the first time, at least one of:
adjust a cytometric instrument parameter based on the first data array, or
reconcile a first cytometric measurement of the first cytometric instrument with a second cytometric measurement of a second cytometric instrument different from the first cytometric instrument, based on at least one of the first data array or a second data array associated with the second cytometric instrument.

2. The non-transitory, processor-readable medium of claim 1, further storing instructions to cause the processor to computationally adjust at least one of a side scatter signal or a forward scatter signal based on the first data array and a second data array, the first data array associated with a first time, and the second data array associated with a second time occurring after the first time and after a modification to a setting of the first cytometric instrument.

3. The non-transitory, processor-readable medium of claim 1, wherein the plurality of scatter signal datapoints further includes:
data representing at least one medium forward scatter signal output, and
data representing at least one medium side scatter signal output.

4. The non-transitory, processor-readable medium of claim 1, wherein the first data array includes a two-dimensional arrangement of the scatter signal datapoints from the plurality of scatter signal datapoints.

5. The non-transitory, processor-readable medium of claim 1, wherein the first data array is generated via a single acquisition run of the first cytometric instrument, using a hydrogel particle formulation.

6. The non-transitory, processor-readable medium of claim 5, wherein a difference between the at least one low forward scatter signal output and the at least one high forward scatter signal output is due to at least one of a monomer/crosslinker ratio of the hydrogel particle formulation, a gel fraction of the hydrogel particle formulation, or a particle size associated with the hydrogel particle formulation.

7. The non-transitory, processor-readable medium of claim 5, wherein a difference between the at least one low side scatter signal output and the at least one high side scatter signal output is due to at least one of a nanoparticle loading of the hydrogel particle formulation, a hydrogel porosity of the hydrogel particle formulation, or a protein conjugation associated with the hydrogel particle formulation.

8. (canceled)

9. The non-transitory, processor-readable medium of claim 1, wherein the first data array is unique to the first cytometric instrument and the second data array is unique to the second cytometric instrument.

10-11. (canceled)

12. The non-transitory, processor-readable medium of claim 1, wherein the plurality of scatter signal datapoints further includes:
data representing at least one additional level of forward scatter signal output; and
data representing at least one additional level of side scatter signal output.

13. A non-transitory, processor-readable medium storing instructions that, when executed by a processor, cause the processor to:
identify a first plurality of scatter signal datapoints generated by a first flow cytometer, the first plurality of scatter signal datapoints including:
(i) data representing forward scatter at a first signal output level,
(ii) data representing forward scatter at a second signal output level greater than the first signal output level,
(iii) data representing forward scatter at a third signal output level greater than the second signal output level,
(iv) data representing side scatter at a fourth signal output level,
(v) data representing side scatter at a fifth signal output level greater than the fourth signal output level, and
(vi) data representing side scatter at a sixth signal output level greater than the fifth signal output level; and
at least one of:
automatically adjust a control parameter of the first flow cytometer based on the first plurality of scatter signal datapoints, or
reconcile a first set of at least one measurement of the first flow cytometer with a second set of at least one measurement of a second flow cytometer different from the first flow cytometer, based on at least one of the first plurality of scatter signal datapoints or a second plurality of scatter signal datapoints associated with the second flow cytometer.

14. The non-transitory, processor-readable medium of claim 13, further storing instructions to cause the processor to cause display, via a user interface, of the first plurality of scatter signal datapoints such that (i) through (vi) are depicted as clustered data populations spaced apart from one another.

15. The non-transitory, processor-readable medium of claim 13, further storing instructions to cause the processor to cause display, via a user interface, of the first plurality of scatter signal datapoints such that (i) through (vi) are arranged in a two-dimensional array.

16. The non-transitory, processor-readable medium of claim 13, wherein:
the automatic adjustment of the control parameter of the first flow cytometer is based on the first plurality of scatter signal datapoints, and
the automatic adjustment compensates for at least one of an instrument degradation of the first flow cytometer, a signal drift of the first flow cytometer, or noise.

17. The non-transitory, processor-readable medium of claim 13, wherein:
the automatic adjustment of the control parameter of the first flow cytometer is based on the first plurality of scatter signal datapoints, and
the automatic adjustment improves a response linearity across multiple subsequent measurements of the first flow cytometer.

18. The non-transitory, processor-readable medium of claim 13, further storing instructions to cause the processor to modify sample data based on the first plurality of scatter signal datapoints.

19. The non-transitory, processor-readable medium of claim 18, wherein the sample data includes sample data generated by the first flow cytometer and sample data generated by the second flow cytometer.

20. The non-transitory, processor-readable medium of claim 13, wherein the plurality of scatter signal datapoints further includes:
(vii) data representing forward scatter at a seventh signal output level greater than the third signal output level; and
(viii) data representing side scatter at an eighth signal output level greater than the sixth signal output level.

21-24. (canceled)

25. A non-transitory, processor-readable medium storing instructions that, when executed by a processor, cause the processor to:
receive, at the processor, a first data array and a second data array each associated with a cytometric instrument, the first data array including a plurality of scatter signal datapoints that includes:
data representing at least one low forward scatter signal output,
data representing at least one high forward scatter signal output,
data representing at least one low side scatter signal output, and
data representing at least one high side scatter signal output; and
the second data array including scatter signal datapoints associated with a sample of interest; and
define one or more gates for cell populations within the sample of interest relative to a position of the plurality of scatter signal datapoints of the first data array.

26. The non-transitory, processor-readable medium of claim 25, further storing instructions to cause the processor to:
detect the position of the plurality of scatter signal datapoints of the first data array by detecting clusters of scatter signals using a machine learning method.

27. (canceled)

28. The non-transitory, processor-readable medium of claim 25, further storing instructions to cause the processor to:
receive a third data array including scatter signal datapoints corresponding to an unknown sample of interest;
receive a fourth data array including a plurality of scatter signal datapoints corresponding to the plurality of scatter signal datapoints of the first data array; and
map the one or more gates to the third data array based on detected clusters of scatter signals within the plurality of scatter signal datapoints of the fourth data array to automatically gate cell populations within the unknown sample of interest.
